(19) United States
(12) Patent Application Publication
(10) Pub. No.: US 2004/0063597 A1
(43) Pub. Date: Apr. 1, 2004

(54) Fabric care compositions

(76) Inventors: Matha J. Adair, Pleasanton, CA (US); Leslie S. Finn, Pleasanton, CA (US); Michael J. Petrin, Pleasanton, CA (US); Cheryl H. Rodriguez, Pleasanton, CA (US); Philip C. Shanks, Oakland, CA (US); Gregory Van Buskirk, Pleasanton, CA (US); Malcolm A. De Leo, Pleasanton, CA (US); Hanneliese S. Selbach, Pleasanton, CA (US); Maria G. Ochomogo, Pleasanton, CA (US)

Correspondence Address: RAY K. SHAHANI, ATTORNEY AT LAW, Twin Oaks Office Plaza, 477 Ninth Avenue, Suite 112, San Mateo, CA, 94402-1854, US

(21) Appl. No.: 10/259,179

(22) Filed: Sep. 27, 2002

(51) Int. Cl. C12S 9/00

(52) U.S. Cl. 510/276; 510/392

(57) ABSTRACT

A non-liquid, liquid, liquid-gel or gelled fabric care composition and method of use comprising:

(a) one or more fabric care enzymes, the fabric care enzymes effective for aiding in preventing pilling fuzzing, staining and other deterioration of fabric fibers during the wash process;

(b) one or more UV protectants, the one or more UV protectants for brightening and preventing light caused photo fading or other damage to fabrics;

(c) one or more surface active dispersing, emulsifying and/or solubilizing agent, the one or more surface active dispersing, emulsifying and/or solubilizing agent principally comprised of surfactants, co-surfactants, hydrotropes and solvents selected to solubilize or stabilize the composition;

(d) one or more dye-transfer inhibitors, anti-redeposition agents or dye sequestrants, the one or more dye-transfer inhibitors, anti-redeposition agents or dye sequestrants to prevent re-deposition of dyes which have become transient from other fabrics;

(e) one or more dye, pigment and fabric color fixative or finish protectant, the dye, pigment and fabric color fixative or finish protectant to lock-in dyes and pigments to prevent their loss in quantity or quality during soaking or washing;

(f) optionally, one or more textile lubricant and/or textile softening agent, the lubricant and/or textile softening agent to coat the textiles and reduce inter-fiber and fiber surface friction;

(g) one or more hardness and metal ion sequestrants and crystal growth inhibitors, the hardness and metal ion sequestrants and crystal growth inhibitors to bind free ions to prevent formation of insoluble precipitate compounds;

(h) one or more chlorine and/or active oxygen scavengers or neutralizers which act to neutralize oxidizing agents, i.e., those species with oxidation potential; and

(i) optionally, one or more from the following: handling, storage, processing agents to modify elastic and viscous phase properties, anti-foaming or frothing agents, anti-microbial, anti-bacterial or anti-fungal agents, pH buffer, adjustment, aesthetic dyes and/or fragrances.

### FIELD OF THE INVENTION

The present invention relates in general to fabric cleaning, color and care compositions, and in particular to a color and fabric care composition for use prior to, during or after washing of textiles or fabrics, such as in a pre-soak, wash cycle or rinse, for maintaining color and overall fabric quality.

### BACKGROUND OF THE INVENTION

Since the development of electric washing machines and before, laundry detergents have been formulated primarily containing soaps or detergents for cleaning. Numerous agents have been considered and found to have very interesting and beneficial aspects in this regard. Moreover, given the advances in the chemical industry throughout the twentieth century, novel approaches to solving age-old problems, such as color-fading and yellowing, are now available.

It is known, for example, that fading is caused by a variety of mechanisms. These include phot fading caused by the sun, other forms of UV radiation, pilling, or fuzzing of superficial layers of the fabric, dye or color loss, bleeding, transfer and/or dye re-deposition in a washing process, deposition or accumulation of common, surfactant-dispersible or soluble soils or stains, fabric wear caused by stiffness or surface friction, abrasion or crystallization and deposition of hardness and metal ions, excess soaps or surfactants, etc.

However, despite advances in understanding the numerous causes of fading, there remains a need to provide a color care composition and method of use to protect fabrics and textiles, in particular clothing and other domestic fabrics, from the combined effects of wear, fading, chlorine-damage and dye transfer or redeposition. The prior art has failed to recognize the importance of the fact that fading is caused by a plurality of ;mechanisms, as described above. Thus, the prior art is completely devoid of any suggestion that selectively combining various color care ingredients into a single color care composition will provide a means for providing enhanced color care for all textiles in a general, multi-purpose application.

U.S. Pat. No. 4,435,307 teaches the use of a cellulytic enzyme derived from Humicola insolens as a harshness reducing detergent additive. Other uses of cellulytic enzymes mentioned in the art involve soil removal from and color clarification of fabric. The use of cellulytic enzymes for harshness reduction of cotton-containing fabrics was suggested and demonstrated nearly 20 years ago. Cellulases generated in nature, e.g. by a single microbial species, are indeed complex mixtures of cellulytic enzymes. Their use has not become widespread and of great practical utility.

FIG. 1 is a table of dye classifications of the prior art. Dyes and pigments can be classified according to their bleach fastness, and fiber type substrate for washable fabrics.

A dye transfer inhibitor (or DTI) according to the present invention is any solubilized or dispersed substance which prevents the undesirable discoloration of items in a wash liquor by extraneous or free flowing dyes that have been given up by items being laundered. The dye transfer inhibitor can achieve this goal by a variety of techniques including, but not necessarily limited to: suspending the dye in the wash liquor; solubilizing the dye in such a manner that it is unavailable for re-deposition onto a wash item; reducing the affinity of the dye for a textile substrate; fixing the dye to the fabric; trapping the dye; precipitating out the dye; etc. Alternately, the dye transfer inhibitor may also adsorb, absorb, or otherwise become associated with any extraneous dyes present in the wash solution in a manner similar to the functioning of the dye absorber. The alternate terms “take-up”, “eliminate”, “scavenge” and “sequester” are understood to be equivalent terms that will be used herein to refer to the mechanism or mechanisms by which the dye transfer inhibitor is responsible for preventing undesirable bleeding or color re-deposition of extraneous dye or dyes in the wash liquor from taking place onto wash items from which the dyes or colorants did not originate.

A key feature is that the total amount of dye transfer inhibitor which is used should be less than the amount required for complete removal of all extraneous dyes from the wash liquor. If there is too much dye transfer inhibitor present in the wash liquor, the dye transfer inhibitor can effect premature fading of the fabric. Without being bound by theory, Applicants believe that this is due to disruption of the equilibrium between dye on the fabric and dye released into solution. Thus, dye transfer inhibitors which scavenge extraneous dyes to too large an extent force the equilibrium such that more dye is released from the fabric.

This invention is also related to compositions and methods of their use for preventing fabric encrustation by decreasing or suppressing the formation of encrustation residue when using detergent applications and formulations during fabric washing operations with “hard water.” The growth of insoluble compounds on fabric surface (fabric encrustation) from repeated washing with non-phosphate detergents in “hard water” is a negative effect in which the appearance and feel of the fabric are affected. The fabric acquires a rough feel and colored garments have a faded appearance. The insoluble compounds primarily are calcium and magnesium carbonate precipitates caused when hard water containing calcium and magnesium ions react with builders, such as sodium carbonate, typically used in non-phosphate detergents. Therefore, the prevention of encrustation or the deposition of insoluble compounds formed during the washing process with “hard water” is strongly desired.

The general problem of the formation of deposits as spots and films on the articles in the wash, and on the dishwasher machine parts is well known in the art. Whilst the general problem of deposit formation is known, a full understanding of the many facets of the problem is however still an active area of research. A range of deposit types can be encountered. The redeposition of soils or the breakdown products thereof, which have previously been removed from the soiled fabric in the washload, provides one deposit type. Insoluble salts such as calcium carbonate, calcium fatty acid salts (lime soaps), or certain silicate salts are other common deposit types. Composite deposit types are also common. Indeed, once an initial minor deposit forms it can act as a “seeding centre” for the build up of a larger, possibly composite, deposit structure.

The compositions and processes herein may preferably employ one or more heavy metal (copper, iron, etc.) chelating agents (“chelators”). Such water-soluble chelating agents can be selected from the group consisting of amino carboxylates, amino phosphonates, polyfunctionally-substituted aromatic chelating agents and mixtures thereof, all as hereinafter defined. Without intending to be bound by theory, it is believed that the benefit of these materials is due in part to their exceptional ability to remove copper and nickel ions (as well as other cations such as manganese, iron, and the like) from aqueous solutions by formation of soluble chelates. Surprisingly, these chelating agents also appear to interact with dyes and optical brighteners on fabrics which have already been undesirably affected by interactions with copper or nickel cations in the laundry process, with the attendant color change and/or drabness effects. By the present invention, the color, whiteness and/or brightness of such affected fabrics are substantially improved or restored.

Chlorine is used in municipal water systems to sanitize water. To ensure that the water is safe for human consumption, typically there is a small residual amount, typically about 1 to 2 parts per million (ppm), of chlorine is left in the water. At least about 10% of U.S. households has about 2 ppm or more of chlorine in its tap water at some time. It has been found that this small amount of chlorine in the tap water can also contribute to fading or color changes of some fabric dyes. Thus, chlorine-induced fading of fabric colors over time can result from the presence of residual chlorine in the wash or rinse water. Accordingly, the present invention preferably also employs a chlorine scavenger. Moreover, the use of such chlorine scavengers provides a secondary benefit due to their ability to eliminate or reduce the chlorine odor on fabrics. Chlorine scavengers are materials that react with chlorine, or with chlorine-generating materials, such as hypochlorite, to eliminate or reduce the bleaching activity of the chlorine materials. For color fidelity purposes, and as an option, it is generally suitable to incorporate enough chlorine scavenger to neutralize about 1-10 ppm chlorine in the laundry bath, typically to neutralize at least about 1 ppm in the laundry bath. For the optional and/or additional elimination or reduction of fabric chlorine odor resulting from the use of a chlorine bleach in the wash, the compositions should contain enough chlorine scavenger to neutralize at least about 10 ppm in the laundry bath.

### SUMMARY AND ADVANTAGES OF THE INVENTION

The present invention is a fabric care composition comprising:

(a) one or more UV protectants, the one or more UV protectants for brightening and preventing light caused photo fading or other damage to fabrics;

(b) one or more fabric care enzymes, the fabric care enzymes effective for aiding in preventing pilling, fuzzing, stain removal and other deterioration of fabric fibers during the wash process;

(c) one or more dye-transfer inhibitors, anti-redeposition agents or dye sequestrants, the one or more dye-transfer inhibitors, anti-redeposition agents or dye sequestrants to prevent re-deposition of dyes which have become transient from other fabrics;

(d) optionally, one or more surface active dispersing, emulsifying and/or solubilizing agent, the one or more surface active dispersing, emulsifying and/or solubilizing agent principally comprised of surfactants, co-surfactants, hydrotropes and solvents selected to solubilize or stabilize the composition;

(e) optionally, one or more dye, pigment and fabric color fixative or finish protectant, the dye, pigment and fabric color fixative or finish protectant to lock-in dyes and pigments to prevent their loss in quantity or quality during soaking or washing;

(f) optionally, one or more textile lubricant and/or textile softening agent, the lubricant and/or textile softening agent to coat the textiles and reduce inter-fiber and fiber surface friction;

(g) optionally, one or more hardness and metal ion sequestrants and crystal growth inhibitors, the hardness and metal ion sequestrants and crystal growth inhibitors to bind free ions to prevent formation of insoluble precipitate compounds;

(h) optionally, one or more chlorine and/or active oxygen scavengers or neutralizers which act to neutralize oxidizing agents, i.e., those species with oxidation potential; and

(i) optionally, one or more chemicals from the following: handling, storage, processing agents to modify elastic and viscous phase properties, anti-foaming or frothing agents, anti-microbial, anti-bacterial or anti-fungal agents, pH buffer, adjustment and/or modification, as needed, aesthetic dyes and/or fragrances.

It is an advantage of present invention to provide a liquid, liquid-gel or gelled composition for color and fabric care.

It is a further advantage of the present invention to provide a dry granular or flake composition.

It is a further advantage of the present invention to provide a composition for pre-soak or pre-washing of textiles or fabrics.

It is a further advantage of the present invention to provide a composition for use as an additive to a washing cycle for textiles or fabrics.

It is a further advantage of the present invention to provide a composition for use following washing, such as an additive to a rinse cycle for textiles or fabrics.

It is a further advantage of the present invention to provide a substrate or other structure for delivery of the fabric and color care composition of the present invention, including devices for multiple use, dispensing, etc.

Thus, the present invention comprises a liquid, liquid-gel or gelled composition for color and fabric care.

In a preferred embodiment, the present invention comprises a dry granular or flake composition.

In a preferred embodiment, the present invention comprises a composition for pre-soak or pre-washing of textiles or fabrics.

In a preferred embodiment, the present invention comprises a composition for use as an additive to a washing cycle for textiles or fabrics.

In a preferred embodiment, the present invention comprises a composition for use following washing, such as an additive to a rinse cycle for textiles or fabrics.

In a preferred embodiment, the present invention comprises a substrate or other structure for delivery of the fabric and color care composition of the present invention, including devices for multiple use, dispensing, etc.

In a preferred embodiment, the present invention comprises a method of cleaning a combination of clothes wherein the combination of clothes have a combination of susceptibilities to different types of color damage, the different types of color damage including, but not limited to, color damage caused by UV light, pilling or fuzzing of the clothing, redeposition of color from solution, fading of the color in the washing process, chlorine and color abrasion, the method comprising the steps of: (a) determining the different types of damage which the combination of clothes are susceptible to; and (b) utilizing a composition which provides protection to clothes for each the different types of damage determined in step (a).

In another preferred embodiment, the present invention comprises a method of cleaning clothes susceptible to color damage caused by UV light, pilling/fuzzing of the clothing, redeposition of other color from solution, fading of the color in the washing process, chlorine or color abrasion, the method comprising the steps of: (a) determining whether the clothes to be cleaned are susceptible to color damage caused by UV light, pilling/fuzzing of the clothing, redeposition of other color from solution, fading of the color in the washing process, chlorine or color abrasion; and (b) utilizing a cleaning composition which provides protection to the clothes for color damage caused by UV light, pilling/fuzzing of the clothing, redeposition of other color from solution, fading of the color in the washing process, chlorine or color abrasion, as required.

In another preferred embodiment, the present invention comprises a method of treating a combination of clothes during cleaning wherein the combination of clothes have a combination of susceptibilities to different types of color damage, the different types of color damage including, but not limited to, color damage caused by UV light, pilling or fuzzing of the clothing, redeposition of color from solution, fading of the color in the washing process, chlorine and color abrasion, the method comprising the steps of: (a) determining the different types of damage which the combination of clothes are susceptible to; and (b) utilizing a composition which provides protection to clothes for each the different types of damage determined in step (a).

In another preferred embodiment, the present invention comprises a method of treating clothes susceptible to color damage caused by UV light, pilling/fuzzing of the clothing, redeposition of other color from solution, fading of the color in the washing process, chlorine or color abrasion, the method comprising the steps of: (a) determining whether the clothes to be treated are susceptible to color damage caused by UV light, pilling/fuzzing of the clothing, redeposition of other color from solution, fading of the color in the washing process, chlorine or color abrasion; and (b) utilizing a treatment composition which provides protection to the clothes for color damage caused by UV light, pilling/fuzzing of the clothing, redeposition of other color from solution, fading of the color in the washing process, chlorine or color abrasion, as required.

In another preferred embodiment, the present invention comprises a color care composition for treating clothes susceptible to color damage caused by UV light, pilling/fuzzing of the clothing, redeposition of other color from solution, fading of the color in the washing process, chlorine or color abrasion, the composition comprising: (a) a UV protecting effective amount of one or more UV protectants; (b) an enzymatically effective amount of one or more fabric care enzymes; (c) a dye-transfer inhibiting and anti-redeposition effective amount of one or more dye-transfer inhibitors, anti-redeposition agents or dye sequestrants; (d) a color fixing or finish protecting effective amount of a dye, pigment and fabric color fixative or finish protectant; (e) a chlorine and/or oxygen scavenging effective amount of one or more chlorine and/or active oxygen scavengers or neutralizers; (f) a lubricating or softening effective amount of a textile lubricant and/or softening agent; and (g) a sequestering and crystal growth inhibiting effective amount of hardness and metal ion sequestrants and crystal growth inhibitors and anti-encrustation agents.

In another preferred embodiment, the present invention comprises a method of color treating a plurality of articles of a plurality of different types of fabric to protect them from a plurality of types of color damage, the method comprising the steps of identifying the plurality of fabrics, identifying the plurality of types of color damage which the plurality of articles are susceptible to, and determining therefrom the most effective color care composition for treating the plurality of articles simultaneously.

In a preferred embodiment, the step of determining the most effective color care composition comprises utilizing statistical analysis of the identifications of the plurality of articles, the plurality of fabrics and the plurality of types of color damage which the plurality of articles are susceptible to.

In another preferred embodiment, the color care composition is optimized with regards to providing as much color protection as possible to as many different types of fabric as possible. In another preferred embodiment, the color care composition is optimized with regards to providing as much color protection as possible to the fabrics identified the most frequently. In another preferred embodiment, the color care composition is optimized with regards to providing as much color protection as possible from as many different sources of color damage identified as possible. In another preferred embodiment, the color care composition is optimized with regards to providing as much color protection as possible from the sources of color damage identified most frequently.

In another preferred embodiment, the present invention comprises a method of formulating a color care composition wherein the composition is for use treating a plurality of articles made of a plurality of types of fabric to protect them from color damage associated with a plurality of causes, the method comprising the steps of identifying the plurality of types of fabrics, identifying the plurality of different types of color damage which the plurality of articles are susceptible to, and determining therefrom the most effective color care composition for treating the plurality of articles simultaneously.

In another preferred embodiment, the present invention comprises a method of formulating a color care composition wherein the composition is used to treat a large number of different types of articles of clothing made of a large number of different types of fabric and to protect them from color damage associated with a large number of different causes, the method comprising the steps of identifying the large number of different types of articles of clothing, identifying the types of fabrics used in the large number of articles of clothing, identifying the large number of different types of color damage which the large number of different types of fabric are susceptible to, and determining therefrom the most effective color care composition for treating the large number of articles simultaneously.

### BRIEF DESCRIPTION OF THE DRAWINGS

FIG. 1 is a table of dye classifications of the prior art.

FIG. 2 is a table and graph of results of statistical analysis of the data generated by the experiments.

FIG. 3 is a representative graph of experimental data showing the effect of Carezyme® cellulase on tensile strength of fabric.

FIG. 4 is a representative graph of experimental data showing the reduction in tensile strength of fabric after treatment with Carezyme® cellulase.

FIG. 5A is a representative illustration of a woven cellulose-containing fabric under magnification showing individual woven threads in essentially new condition.

FIG. 5B is a representative illustration of a woven cellulose-containing fabric under magnification showing individual woven threads after substantial wear and abrasion has resulted in pilling.

FIG. 5C is a representative illustration of a woven cellulose-containing fabric under magnification showing fabric after treatment with cellulase enzyme.

FIG. 5D is a representative illustration of a woven cellulose-containing fabric under magnification showing fabric after repeated treatments with cellulase enzyme.

FIG. 6 is a table of experimental data showing examples of fabric susceptibility to various modes of color and quality loss.

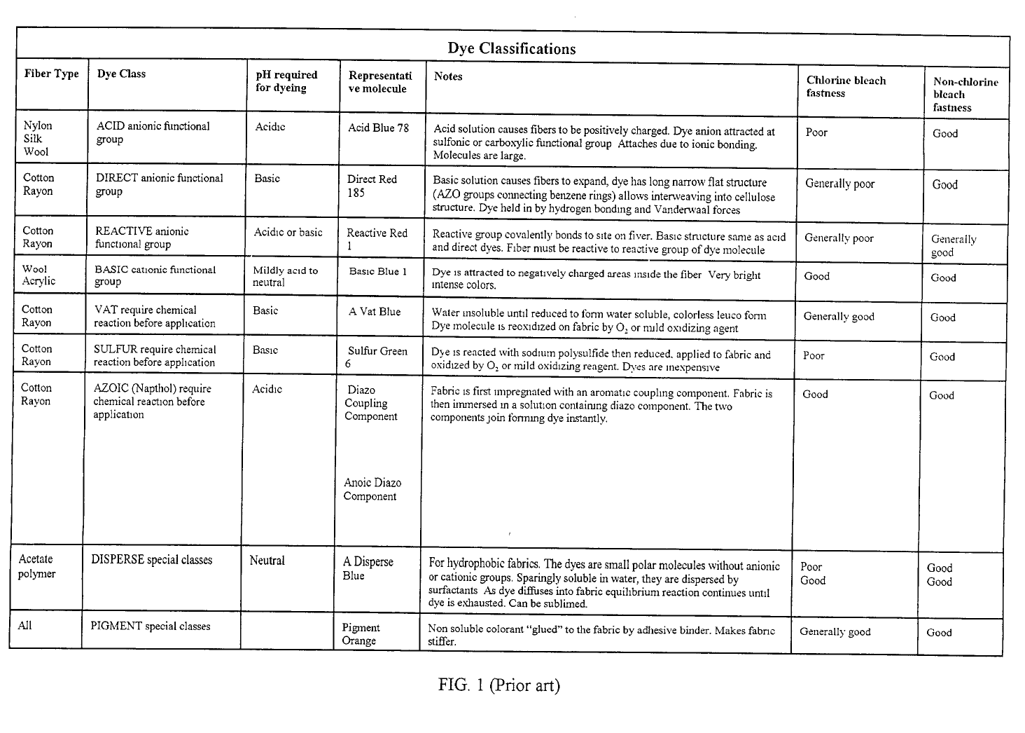

### DETAILED DESCRIPTION OF THE PREFERRED EMBODIMENTS

The description that follows is presented to enable one skilled in the art to make and use the present invention, and is provided in the context of a particular application and its requirements. Various modifications to the disclosed embodiments will be apparent to those skilled in the art, and the general principals discussed below may be applied to other embodiments and applications without departing from the scope and spirit of the invention. Therefore, the invention is not intended to be limited to the embodiments disclosed, but the invention is to be given the largest possible scope which is consistent with the principals and features described herein.

The present invention is a fabric care composition comprising:

(a) one or more fabric care enzymes, the fabric care enzymes effective for aiding in preventing pilling fuzzing, staining and other deterioration of fabric fibers during the wash process;

(b) one or more UV protectants, the one or more UV protectants for brightening and preventing light caused photo fading or other damage to fabrics;

(c) one or more dye-transfer inhibitors, anti-redeposition agents or dye sequestrants, the one or more dye-transfer inhibitors, anti-redeposition agents or dye sequestrants to prevent re-deposition of dyes which have become transient from other fabrics;

(d) one or more dye, pigment and fabric color fixative or finish protectant, the dye, pigment and fabric color fixative or finish protectant to lock-in dyes and pigments to prevent their loss in quantity or quality during soaking or washing;

(e) one or more textile lubricant and/or textile softening agent, the lubricant and/or textile softening agent to coat the textiles and reduce inter-fiber and fiber surface friction;

(f) one or more hardness and metal ion sequestrants and crystal growth inhibitors, the hardness and metal ion sequestrants and crystal growth inhibitors to bind free ions to prevent formation of insoluble precipitate compounds;

(g) one or more chlorine and/or active oxygen scavengers or neutralizers which act to neutralize oxidizing agents, i.e., those species with oxidation potential;

(h) one or more surface active dispersing, emulsifying and/or solubilizing agent, the one or more surface active dispersing, emulsifying and/or solubilizing agent principally comprised of surfactants, co-surfactants, hydrotropes and solvents selected to solubilize or stabilize the composition; and

(i) one or more chemicals from the following: handling, storage, processing agents to modify elastic and viscous phase properties, anti-foaming or frothing agents, anti-microbial, anti-bacterial or anti-fungal agents, pH buffer, adjustment and/or modification, as needed, aesthetic dyes and/or fragrances.

The preferred embodiment is a liquid, liquid-gel or gelled composition for color and fabric care. It can also be provided as a dry granular or flake composition. The composition can be used either as a pre-soak or pre-washing of textiles or fabrics, an additive to a washing cycle or following washing, such as an additive to a rinse cycle. The preferred embodiment also comprises a substrate or other structure for delivery of the fabric and color care composition of the present invention, including devices for multiple use, dispensing, etc.

Enzymes

The first category of active chemicals comprises one or more fabric care enzymes. In a preferred embodiment, cellulase enzymes are particularly effective on cellulosic (cotton) fibers. The presence of these enzymes in the wash or rinse of fabrics serves to prevent pilling and fuzzing of fabrics during the washing process. During these processes, abrasion and fiber damage result in formation of loose fibers or “fuzz” that can become entangled and form “pills”. Cellulase enzymes also act to remove existing pilling and fuzzing formed during wear so as to restore the original fabric appearance during subsequent wash or other treatment cycles. Thus, fabrics with pills and fuzz often exhibit a worn appearance. Furthermore, given the propensity of damaged fibers to suffer further dye and pigment loss during both laundering and wear which exposes the un-dyed fiber core, this results in a faded appearance.

In a preferred embodiment, enzymatic softening of cellulose-containing fabrics, primarily cotton-containing fabrics, as well as soil removal and color clarification is provided by a cellulase fraction enriched in endoglucanase activity. The present invention relates to a cellulase preparation which comprises preferably above about 40% (on the basis of total protein as determined from the OD at 280 nm) of an endoglucanase component which exhibits a CMC-endoase activity (as defined below) of above about 5 CMC-endoase units per mg of total protein, or more or less, and a cellulose affinity viscosity unit (CAVU) activity (as defined below) of above about 50% or more or less under alkaline conditions. In preferred embodiments, the present invention relates to utilization of a cellulase preparation, which comprises at least 50% (by weight of the total cellulase content) of a substantially homogenous endoglucanase component which exhibits a CMC-endoase activity of at least 5 CMC-endoase units per mg of total protein and a CAVU activity of at least 50% under alkaline conditions.

In the present context, the term “CMC-endoase activity” refers to the endoglucanase activity of the endoglucanase component in terms of its ability to degrade cellulose to glucose, cellobiose and triose, as determined by a viscosity decrease of a solution of carboxymethyl cellulose (CMC) after incubation with the cellulase preparation. The term “CAVU activity” refers to the affinity of the endoglucanase component towards cellulose. This affinity may conveniently be determined by measuring the CMC-endoase activity of a solution of the cellulase preparation under certain standard conditions before and after incubation of the enzyme solution with a cellulose-containing material. The affinity of the endoglucanase component towards cellulose may subsequently be expressed in percent CAVU units which is calculated as the difference between the CMC-endoase activity of the untreated and cellulose-treated enzyme solution divided by the activity of the untreated solution and multiplied by 100.

In the context of this invention, cellulase activity can be expressed in ECU. Cellulolytic enzymes hydrolyze CMC, thereby increasing the viscosity of the incubation mixture. The resulting reduction in viscosity may be determined by a vibration viscosimeter (e.g. MIVI 3000 from Sofraser, France). Determination of the cellulolytic activity, measured in terms of ECU, may be determined according to the following analysis method (assay): The ECU assay quantifies the amount of catalytic activity present in the sample by measuring the ability of the sample to reduce the viscosity of a solution of carboxy-methylcellulose (CMC). The assay is carried out at 40 .degree. C.; pH 7.5; O.1M phosphate buffer; time 30 min; using a relative enzyme standard for reducing the viscosity of the CMC(carboxymethylcellulose Hercules 7 LFD) substrate; enzyme concentration approx. 0.15 ECU/ml.

It has been found that, in case of using an alkaline endoglucanase such as the 43 kD H. insolens, DSM 1800, endoglucanase or the mentioned modified variants thereof, it may be advantageous to carry out the method of the present invention at an alkaline pH below about 9, more preferably at a pH of from about 7 to about 9, especially at a pH of about 8.0. In preferred embodiments, the pH is below about 9, more preferably slightly acidic at a pH of from about 5 to about 7, especially at a pH of about 6.0.

Although the useful cellulase may be used as such in the composition and method of the present invention, it is preferred that it is formulated into a suitable composition. Thus, the useful cellulase may be used in the form of a granulate, preferably a non-dusting granulate, a liquid, liquid-gel or gelled, in particular a stabilized liquid, a slurry, or in a protected form. Dust free granulates may be produced, e.g. as disclosed in U.S. Pat. Nos. 4,106,991 and 4,661,452 (both to Novo Nordisk A/S) and may optionally be coated by methods known in the art. Liquid, liquid-gel or gelled enzyme preparations may, for instance, be stabilized by adding a polyol such as e.g. propylene glycol, a sugar or sugar alcohol or acetic acid, according to established methods. Other enzyme stabilizers and protectors are well known in the art.

The performance of enzymes greatly depends on process conditions such as e.g. pH and temperature. In accomplishing the process of this invention, of course, factors such as e.g. pH-dependent performance and thermal stability should be taken into consideration in the choice of cellulytic enzymes. Other conditions such as e.g. the addition of wetting agents, etc., also depend on the overall process to be performed, as well as the enzyme employed.

It will be known by those skilled in the art that several known cellulases are active at an acid pH and relatively inactive at alkaline pH values. Due to the alkalinity of most washing detergents, this characteristic makes the cellulase preparation high in endoglucanase fraction particularly useful for washing purposes.

Numerous patents and other documents describe various preferred cellulose enzymes. The following are hereby incorporated by reference herein in their entireties: WO 89/09259 published Oct. 5, 1989 by Schulein et al; U.S. Pat. No. 5,648,263 issued Jul. 15, 1997 by Schulein et al.; U.S. Pat. No. 5,691,178 issued Nov. 25, 1997 to Schulein et al.; WO 91/17243 published Nov. 14, 1991 to Woldike et al.; WO/9117244 published Nov. 14, 1991 to Rasmussen et al.; WO 91/19807 published Dec. 26, 1991 to Rosholm et al.; WO 92/18599 published Oct. 29, 1992 Wagner et al; WO 94/07998 published Apr. 14, 1994 to Schulein et al.; and WO 95/02675 published Jan. 26, 1995 to Schulein et al. These publications describe preparation s useful for reducing the harshness of cotton-containing fabrics and for reducing the rate at which a cotton-containing fabric becomes harsh by which the fabrics are treated with a preparation obtained from a fungus, wherein the cellulase preparation comprises a substantially homogeneous endoglucanase component having a pH optimum, a certain CMC endoase activity, a certain CAVU activity at a certain pH, preferably with no cellobiohydralase activity, the cellulase composition endogenous to strains of Humicola, Myceliophthora, Fusarium, etc.

A further example of a suitable enzyme is sold under the trade name Carezyme® (Novo Nordisk) cellulase enzyme product. Carezyme® is a cellulase produced by submerged fermentation of a genetically modified Aspergillus microorganism. Carezyme® removes the microfibrils, caused by wear and washing, which protrude from a fiber. The activity of Carezyme® depends on the conditions in which the enzyme is exposed (pH, temperature, other ingredients in the product). Carezyme® can be obtained with a cellulytic activity of 4500 ecu/gram or higher. Other cellulase preparations will be known to those skilled in the art and their use as described herein will be included within the scope of the present invention.

In other preferred embodiments of the present invention, enzymes include hydrolases, such as carbohydrases (amylases), proteases and esterases (lipases). Preferred proteases, which attack protein-based staines such as blood and grass stains, include alkaline proteases available from Novo Industri, Copenhagen, Denmark, under the trade names Savinase, Alcalase, and Esperase. Among the commercially available amylases are those which attack carbohydrate and starch-based stains, such as an amylase available from Societe Rapidase under the trade name of Rapidase, and from Miles Laboratories under the trade name of Milezyme.

In a preferred embodiment, the amounts of fabric care enzymes present are generally about 0.001 to about 5.00%, more preferably about 0.002 to about 1.00%, and most preferably about 0.745% fabric care enzymes. These are generally considered to be fabric care enzyme effective amounts.

UV Protectants

A second category comprises UV protectants, It will be understood by those skilled in the art that the present invention encompasses the use of any such UV protectants for color care, i.e. to prevent fading, discoloration, etc. As used herein, the term UV shall include either one or both of UVA and UVB radiation. However, since it is mostly UVA that affects colors, those compounds which block or absorb, or otherwise protect more specifically against UVA, as compared to UVB, will be useful in the present invention.

In a preferred embodiment, the UV protectants comprise a novel combination of two or more synergistic classes of light protective materials, such as those consisting of one or more UV light absorbing compounds combined with those consisting of one or more light stabilizing compounds. Free radical scavengers are generally well known and considered herein to be non-limiting examples one type or family of light stabilizing compounds. The combination of these two classes of materials acts to synergistically reduce damage to fabric dyes and finishes which are susceptible to light radiation to a greater extent than either class of material used singly.

The former class of actives consist of materials that strongly absorb UV light, thereby reducing the level of UV incident to the fiber surface and deposited materials thereon. Included in this class are some conventional fluorescence whitening agents (FWA) that absorb UV light and emit blue fluorescent light to contribute to color brightening. Most preferred are those combinations of UV absorbers that do not interfere with the performance of the FWA materials present either in the formulation, or those normally present during use originating from laundry additives and detergents used in combination with the inventive compositions.

FWAs or other optical brighteners in modern detergent and other fabric and color care compositions replaces, to a certain degree, blueing agents used in the past to overcome the light yellow hue of cleaned cotton. FWAs are organic compounds which are able to convert invisible UV-light (about 240 nm to about 700 nm) into visible blue light. A whiteness with a blue hue as a result of the addition of a FWA is generally perceptible as real whiteness. Four major types of FWAs are available today:

cotton FWAs;

chlorine resistant FWAs;

polyamide FWAs; and

polyester FWAs.

Preferred FWAs useful in the present invention are built upon five principal basic structures—stilbene, biphenyl stilbene, coumarin, quinolone, biphenyl pyrazoline and a combination of benzoxazole or benzimidazole with conjugated systems. Fluorescent whitening agents used in a washing solution behave like textile dyes. Cotton FWAs and chlorine resistant FWAs are bound substantively to the fibers by means of hydrogen bonds. The effect on resin finished cotton is usually less pronounced. the effect of polyamide and polyester FWAs is dependent on their diffusion capability into the fiber surface. Preferred FWAs used in the present invention have a high affinity to fibers, are stable and fast against oxygen, light and chlorine.

Preferred FWAs include 4,4′-bis(triazinylamino)-stilbene-2,2′-disulfonic acids, 4,4′-bis-(v-triazole-2-yl)-stilbene-2,2′-disulfonic acids, stilbenyl-napthotriazoles, 4,4′-distyrl-biphenyls, pyrazolines, coumarins, quinolones, bis-(benzimidazole-2-yl)-derivatives, and 2-styryl-benzoxazoles and -napthoxazoles. Another class of sunscreen actives include dibenzoylmethane compounds which provide broad spectrum UV (both UVA and UVB) protection and 4-tert-butyl-4′-methoxydibenzoylmethane, in particular, is approved for global use. Stabilized sunscreen and UV absorbing products are also available.

FWAs, also known as optical brighteners, or brighteners, are adsorbed by textile fibers and impart to the fabric an improved degree of whiteness or brightness (fluorescene) by means of their chemical ability to absorb ultraviolet radiation and re-emit visible radiation. In order to provide substantial fabric whitening, it is desirable to combine the optical brightening capacity of fluorescent whitening agents with an effective bleach. Brighteners include compounds such a stilbene brighteners and their derivatives, styrylnaphthalene brighteners and their derivatives and styrene brighteners and their derivatives. Particularly suitable compounds include the disodium salt of 2,2-(4,4′-biphenylene divinylene)dibenzenesulfonic acid (manufactured and sold under the name Tinopal CBS-X by Ciba-Geigy Corporation of Greensboro, N.C.) and Phorwhite BHC 766 (manufactured by Mobay Corporation of Union, N.J.). Alkaline earth, alkali metal, zinc, and other multivalent salts (such as the metals of Groups IIIA of the Periodic Table of the Elements) of these compounds are also suitable brightening agents.

It will be understood that the UV absorbers used in the present invention are not necessarily FWAs. Examples here include 3V Company product Uvasorb MET/C, a UV absorber. Uvasorb MET/C is 2-hydroxy-4-methoxyphenyl phenyl methanone. Other UV absorbers/stabilizers/FWA-UV absorbers suitable include BASF Uvinul N 539T (2-ethyl hexylester 2-cyano-3,3,-diphenyl acrylate), CIBA Specialty Chemicals Tinogard TL, Tinosorb FR, Tinosorb FD, Tinosorb M which includes methylene bis-benzotriazolyl tetramethylbutylphenol), Tinosorb S which includes bis-ethylhexylphenol methoxyphenyl triazine, 3V Optiblanc GL (FWAIUV dual performer), The CP Hall Company HallBrite TQ which includes diethylhexyl naphthalate, HallBrite OS which includes octyl salicylate, HallBrite BHB which includes butyloctyl salicylate, Norquay Technology Helisorb-10 which includes benzophenone-2, Helisorb-11DS which includes benzophenone-9 Roche Vitamins, Inc. Parsol 340 which includes octocrylene, Parsol 5000 which includes 4-methylbenzylidene camphor, Parsol HS which includes phenylbenzimidazole sulfonic acid, BASF Uvinul MC80 which includes octyl methoxycinnamate, ISP Corp. Escalol 507 which includes octyl dimethyl paraaminobenzoic acid, Escalol 577 which includes benzophenone-4, Haarman and Reimer Neo Heliopan MA which includes menthyl anthranilate Neo Heliopan E-100 which includes isoamyl P(note=para)-methoxycinnamate.

The second class of actives of this second category of light protective materials consists of a free-radical scavenger and/or a hindered amine light stabilizer (HALS), both of which are intended to prevent damage from free-radicals generated during irradiation. These components of the fabric care composition of the present invention also prevent damage to oxidation/reduction sensitive dyes, fabric and finishes. Fabrics exposed to light show fading due to photodamage, either in loss of color or in the case of multiple dyes, a change of hue resulting from damage to one or more dyes present. The effect is strongly noted following exposure to sunlight and is thought to occur to a significant, but lesser extent with prolonged indoor fluorescent lighting. Pigments and fabric finishes, typically polymers added to improve dye retention through processing and subsequent wash and wear cycles, are also susceptible to photodamage. U.S. patent application Ser. No. 08/749,735, filed Nov. 15, 1996 entitled COMPOSITION AND METHOD FOR TOPICAL TREATMENT OF VINYL TO PROTECT AGAINST ENVIRONMENTAL EXPOSURE, by Hutchinson et al., is hereby incorporated herein by reference in its entirety, in particular for its teachings of delivering a HALS to protect, in particular against weathering by UV light.

Examples here include 3V Company products butylated hydroxytoluene (BHT) and 3V Company Uvasorb HA77 representing free-radical scavenger and hindered amine light stabilizer materials, respectively. Uvasorb HA77 is decanedioic acid, bis (2,2,6,6-tetramethyl-4-piperidinyl) ester.

In a preferred embodiment, the amounts of UV protectants present are generally about 0.001 to about 20.00%, more preferably about 0.002 to about 1.00%, and most preferably about 0.3 to about 0.5% UV protectant. These are generally considered to be UV protective effective amounts.

Surfactants

A third category of actives, required in the compositions in combination with the second category of light protective materials, consist of surface active dispersing, emulsifying and/or solubilizing agents, principally comprised of surfactants, co-surfactants, hydrotropes and solvents, selected to solubilize or stabilize dispersions of the UV absorbers and stabilizers in the mostly aqueous solutions comprising the inventive composition.

Most preferred are nonionic surfactants and cosurfactants, but also suitable are anionic or combinations of anionic and nonionic surfactants. Surfactants and cosurfactants include cationics, and or combinations of cationics with nonionic surfactants. The wetting/emulsifying/dispersing agent may preferably be a amphoteric or zwitterionic surfactant, or possibly, a hydrotrope. The description is intended to exemplify that a wide variety of surfactants can be used according to the present invention.

The nonionic surfactants may be selected from modified polysiloxanes, alkoxylated alcohols, alkoxylated phenol ethers, glycosides, and the like. Trialkyl amine oxides, and other surfactants often referred to as “semi-polar” nonionics, may also be employed.

Also preferred are modified polysiloxanes. The modified polysiloxane can be an alkoxylated dimethylsiloxane, such as those available from Byk Chemie, such as BYK-345.

Other suitable nonionic surfactants can include other linear ethoxylated alcohols with an average length of 6 to 16 carbon atoms and averaging about 2 to 20 moles of ethylene oxide per mole of alcohol; linear and branched, primary and secondary ethoxylated, propoxylated alcohols with an average length of about 6 to 16 carbon atoms and averaging 0-10 moles of ethylene oxide and about 1 to 10 moles of propylene oxide per mole of alcohol; linear and branched alkylphenoxy (polyethoxy) alcohols, otherwise known as ethoxylated alkylphenols, with an average chain length of 8 to 16 carbon atoms and averaging 1.5 to 30 moles of ethylene oxide per mole of alcohol; and mixtures thereof. The alkoxylated alcohols may include, for example, ethoxylated, and ethoxylated and propoxylated C₆₋₁₆ alcohols, with about 2-10 moles of ethylene oxide, or 1-10 and 1-10 moles of ethylene and propylene oxide per mole of alcohol, respectively. Exemplary surfactants are available from Shell Chemical under the trademarks Neodol and Alfonic, and from Huntsman Chemicals under the trademark Surfonic (e.g., Surfonic L12-6, a C₁₀₋₁₂ ethoxylated alcohol with 6 moles of ethylene oxide, and Surfonic L12-8, a C₁₀₋₁₂ ethoxylated alcohol with 8 moles of ethylene oxide).

The alkoxylated phenol ethers may include, for example, octyl- and nonylphenol ethers, with varying degrees of alkoxylation, such as 1-10 moles of ethylene oxide per mole of phenol. The alkyl group may vary, for example, from C₆₋₁₆, with octyl- and nonyl chain lengths being readily available. Various suitable products are available from Rohm & Haas under the trademark Triton, such as Triton N-57, N-101, N-111, X-45, X-100, X-102, from Mazer Chemicals under the trademark Macol, from GAF Corporation under the trademark Igepal, and from Huntsman under the trademark Surfonic.

Further examples on nonionics include Union Carbide's tri-methyl-nonyl alcohol ethoxylates with brand names Tergitol TMN-3 and Tergitol TMN-10. The TMN-series are “Tri-Methyl Nonanol ethoxylates”. The structures consist of a branched alkyl/hydrocarbon tail and a repeated ethylene oxide head. It will be understood that the tail is the part of the molecule that likes oil, and is otherwise known as hydrophobic or lipophilic. The head is the part of the molecule that likes water—hydrophilic or lipophobic. The branched alkyl tail makes the tail more hydrophobic than a unbranched or straight tail. The ethylene oxide portion is repeated units, termed ethoxylates. They like water and the longer the chain length, the more soluble the surfactant is in water. Thus, alkyl EO-10 (TMN-10) with seven ethylene oxide groups is more soluble in water than alkyl EO-3 (TMN-3).

Other nonionics described in the following paragraphs are also suitable, for example the Tergitol linear ethoxylate sulfates which consist of a linear un-branched alkyl chain and pendant ethoxylate chain with a terminal sulfate group).

Another terminology to describe the solubility is the HLB or hydrophilic/lypophilic balance and is determined by the ratio of surfactant partititioning between an oily organic phase (octanol) and water. Thus higher HLB surfactants are more water soluble, lower HLB surfactants less water soluble. Cloud point is another term used with nonionics, and refers to a temperature at which a 1% solution of the surfactant turns cloudy upon heating. The clouding is actually the surfactant coming out of solution, or losing solubility due to dehydration (water loss) of the ethyloxylate portion of the molecule. Lower cloud points are generally seen with less soluble surfactants since dehydration caused by heating causes them to loose solubility at lower temperatures.

The present invention can employ any nonionic surfactant, including one that is a lower HLB surfactant (HLB between 1-10) capable of solubilizing the hydrophobic UV materials, fragrances and other oils in the formula, and the second is a generally higher HLB surfactant (HLB between 5 and 40) capable of coupling the materials into water. Since we are employing mixed surfactant systems, no specification of cloud point properties is indicated in the invention since mixed systems behave uniquely.

Further suitable nonionic surfactants may include polyoxyethylene carboxylic acid esters, fatty acid glycerol esters, fatty acid and ethoxylated fatty acid alkanolamides, certain block copolymers of propylene oxide and ethylene oxide, and block polymers or propylene oxide and ethylene oxide with propoxylated ethylene diamine. Also included are such semi-polar nonionic surfactants like amine oxides (such as Ammonyx from Stepan and Barlox from Lonza), phosphine oxides, sulfoxides and their ethoxylated derivatives.

The anionic surfactants may include a negatively charged water solubilizing group. Examples of anionic surfactants which may be incorporated into the formulations of the present invention may include the ammonium, substituted ammonium (e.g., mono-di-, and triethanolammonium), alkali metal and alkaline earth metal salts of C.sub.6-C.sub.20 fatty acids and rosin acids, linear and branched alkyl benzene sulfonates, alkyl sulfates, alkyl ether sulfates, alkane sulfonates, alpha olefin sulfonates, hydroxyalkane sulfonates, fatty acid monoglyceride sulfates, alkyl glyceryl ether sulfates, acyl sarcosinates and acyl N-methyltaurides.

A preferred cationic surfactant is morpholinium ethosulfate, such as Forestall (Atlas) G-271. Other suitable cationic surfactants may include the quaternary ammonium compounds in which typically one of the groups linked to the nitrogen atom is a C.sub.12-C.sub.18 alkyl group and the other three groups are short chained alkyl groups which may bear inert substituents such as phenyl groups.

Suitable amphoteric and zwitterionic surfactants containing an anionic water-solubilizing group, a cationic group or a hydrophobic organic group include amino carboxylic acids and their salts, amino dicarboxylic acids and their salts, alkyl-betaines, alkyl aminopropylbetaines, sulfobetaines, alkyl imidazolinium derivatives, certain quaternary ammonium compounds, certain quaternary phosphonium compounds and certain tertiary sulfonium compounds.

U.S. Pat. No. 6,010,994 issued Jan. 4, 2000 to Choy et al. is incorporated herein by reference in its entirety. U.S. Pat. No. 6,022,843 issued Feb. 8, 2000 to Shanks et al. is also incorporated herein by reference in its entirety. These and other types of detergents and surfactants are further described and exemplified in McCutcheon's Emulsifiers and Detergents (1994) in its entirety, and Kirk-Othmer Encyclopedia of Chemical Technology 3rd, Vol. 22, “Surfactants,” pp. 332-432 (1983), both of which are incorporated herein by reference.

Dye Transfer Inhibitor

A fourth category comprises dye and pigment anti-redeposition materials, dye-transfer inhibitors and dye sequestrants, exemplified by polymers such as polyvinylpyrrolidone (PVP), which bind to free dyes liberated during washing to prevent their undesirable redeposition onto other textiles present.

A dye transfer inhibitor (or DTI) according to the present invention is any solubilized or dispersed substance which prevents the undesirable discoloration of items in a wash liquor by extraneous or free flowing dyes that have been given up by items being laundered. The dye transfer inhibitor can achieve this goal by a variety of techniques including, but not necessarily limited to: suspending the dye in the wash liquor; solubilizing the dye in such a manner that it is unavailable for re-deposition onto a wash item; reducing the affinity of the dye for a textile substrate; fixing the dye to the fabric; trapping the dye; precipitating out the dye; etc. Alternately, the dye transfer inhibitor may also adsorb, absorb, or otherwise become associated with any extraneous dyes present in the wash solution in a manner similar to the functioning of the dye absorber. The alternate terms “take-up”, “eliminate”, “scavenge” and “sequester” are understood to be equivalent terms that will be used herein to refer to the mechanism or mechanisms by which the dye transfer inhibitor is responsible for preventing undesirable bleeding or color re-deposition of extraneous dye or dyes in the wash liquor from taking place onto wash items from which the dyes or colorants did not originate.

Further, regardless of the total amount of extraneous dye which could be prevented from redepositing on other wash articles by the dye transfer inhibitor, it is desirable that a certain amount of dye remain available. Applicants have observed that when enough dye transfer inhibitor is added to completely remove extraneous dye, the dye transfer inhibitor may significantly decrease the amount of fluorescent whitening agent deposited on wash items and adversely affect perceived cleaning properties of the detergent. Without being bound by any particular theory, Applicants believe that this is because the dye transfer inhibitor can diminish the fluorescent whitening or brightening features of existing laundry detergents. This may be due to a competitive interaction between the DTI and the brightener. In fact, Applicants understand that several European and at least even one U.S. detergents targeted for colored laundry use have removed brighteners from their formulations altogether so that the performance of dye transfer inhibitors is in no way diminished with regard to dye transfer. An alternate theory that may explain the competition between fluorescent whiteners and dyes for DTI complexation is that the fluorescent whitening agents may be absorbed into the DTI, leaving the DTI with reduced capacity to absorb or scavenge colored dyes.

Materials which may be acceptable as dye transfer inhibitors include, but are not necessarily limited to: polyvinyl pyrrolidone (PVP); polyvinyl alcohol (PVA); polyvinyl imidazole (PVI); polyamine-N-oxides such as polyvinylpyridine-N-oxide (PVNO); hydrophobicly or cationicly modified PVP; copolymers of any of the foregoing; cationic starches; minerals such as magnesium aluminate and hydrotalcite; proteins and hydrolyzed proteins; polyethylene imines; polyvinyl oxazolidone; enzymatic systems including peroxidases and oxidases; oxidants; cationic and amphoteric surfactants; as well as propylene oxide reaction products; polyamino acids such as polyaspartic acid or polyhistidine; block co-polymers of ethylene oxide and propylene oxide, for example, those known by the trade name Pluronic® (BASF); polyamines and polyamides; cationic starches; methyl cellulose; carboxyalkyl celluloses such as carboxymethyl and carboxyethyl cellulose; guar gum and natural gums; alginic acid, polycarboxylic acids; cyclodextrins and other inclusion compounds; and mixtures thereof, etc. In addition to the foregoing, and depending on processing steps and/or conditions, certain dye transfer inhibitors may also be comprised of the same material as the dye absorber, and vice-versa.

In a preferred embodiment, the DTI is PVP (poly vinyl pyrollidone). A structure for PVP is shown as Equation 1:

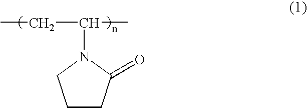

Differences between brands and types of PVP, however, include the average polymer length (molecular weight), typically expressed as grams/mole (g/m) or Daltons and heterogeniety. The polymers are typically fairly long (from as low as 15,000 to about at least 100,000 g/m), thus having tens of thousands of repeating units or binding sites. Heterogeniety refers to the distribution of random chain lengths about the average, which is the molecular weight reported.

PVP is a highly polar nonionic polymer, which complexes with anionic dyes in aqueous solution. The classes of anionic dyes most commonly used on garments are “direct”, “reactive”, and “acid”. The result of the interaction between PVP and dyes in the wash water is a reduction in the amount of dye that is transferred onto clothing. Dye transfer can cause clothing to lose their brightness and can even change their hue. In extreme cases, dye transfer can cause areas of severe dye staining on clothing. The dyes that are most readily complexed by PVP seem to be dyes with larger ratios of SO₃⁻ groups to the molecule size. This type of structure occurs most commonly in direct dyes. It makes sense that the same complexation mechanism that occurs in wash water can occur in aqueous based formulas containing PVP and a dye. The result of this PVP-dye interaction is a discoloration of the formula. This interaction will also reduce the level of PVP available for complexing the fugitive dyes in the wash, therefore reducing the effectiveness of the dye transfer inhibition.

An important aspect of the DTI selected is that it does not interfere with any aesthetic dyes or colorants used in the composition of the present invention. It has been found that dyes used in the color care compositions of the present invention must be carefully selected to ensure that a stable formula color is obtained and that all of the PVP is available for complexing dyes in the wash. This can be achieved by choosing anionic dyes which are non-fabric staining and which contain a minimum number of SO₃⁻ groups for the size of the dye molecule. This type of structure occurs most commonly in the acid class of dyes. (See below.)

The amount of dye transfer inhibitor according to one embodiment of the present invention is about 0.001% to about 25%, more preferably about 0.002 to about 20%, and most preferably about 1%. This is considered a dye-transfer inhibiting and anti-redeposition effective amount. It is to be noted that the dye scavenging efficiency of the dye transfer inhibitor in question will, inter alia, determine the amount of a particular dye transfer inhibitor that should be used.

Another useful soil and clay removal and anti-redeposition agent is a mixture of polyethylene glycol having a selected weight average molecular weight range of between about 1,000 and about 50,000, more preferably between about 5,000 and about 20,000, and a polyacrylate having a selected weight average molecular weight range of between about 1,000 and about 20,000, more preferably between about 3,000 and about 8,000. The present invention contains from about 1% to about 20%, preferably from about 1.5% to about 10% of the polyethylene glycol/polyacrylate mixture. Such mixtures containing polyethylene glycol and polyacrylate are described further in U.S. Pat. No. 4,490,271, issued Dec. 25, 1984 to Spadini et al., which is hereby incorporated herein in its entirety by reference.

Another polyethylene imine polymer which is currently used in a variety of industrial applications goes by the trade name Lupasol® (BASF). Lupasol® has an average size of about 750,000 MW. In a preferred embodiment, the Lupasol® used in the present invention has a molecular weight of between about 1000-2000 MW and about 1,000,000 MW. The chemical structure for Lupasol® is shown below as Equation 2:

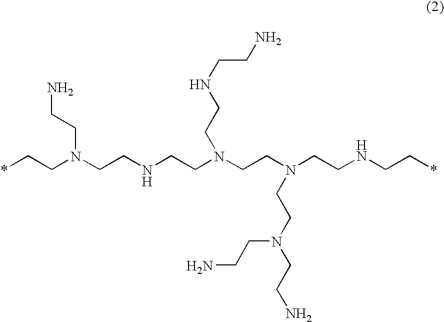

Lupasol® is a highly charged, cationic polymer. Use of about 0.15%, or more or less, provides the utility described herein. It will be understood that as a cationic molecule, its utility is environment dependent to a certain degree. It will be understood that in the presence of other anionic and possibly even non-ionic constituents in the cleaning composition of the present invention, including surfactants, etc., ion pairing and precipitation, among other possible reactions, render the cationic Lupasol® molecule less active. Thus, formulations of the present invention are void/deficient in anionic and non-ionic constituents which may interact with the Lupasol® molecule. However, most non-ionic surfactants and other non-ionic constituents, as well as other cationic surfactants and other cationic constituents, can be used with Lupasol®.

Current benefits Lupasol® are realized in a variety of technological areas such as inks, water treatment, and paper processing. As an inkjet additive, Lupasol® helps prevent the ink from bleeding when the ink is sprayed onto paper. This effect is due to interaction of the polymer and the paper which causes interference with the otherwise familiar capillary, wicking action of ink within untreated paper. This chemistry can be utilized in order to provide dye locking benefits to dyed clothing.

Dye Lock with Lupasol® Experiment

To quantitatively determine the benefits provided by Lupasol®, the following tests were performed.

1. Procedure

100% cotton red and white swatches were used for all experimentation. These commonly used red swatches because of their affinity for releasing dye when dunked in water and because they help simulate clothing that can potentially transfer dyes through the wash mother liquor.

In each experiment either the white or red swatches were dunked into a 0.15% active solution in Lupasol® (750,000 MW polyethyleneimine) and allowed to dry briefly. The treated swatches were then dropped into 200 ml of hot water with an untreated swatch (red if white were treated, white if red were treated) and allowed to sit for several hours. The purpose of this step was to allow the red dye the time it may or may not need to bleed and deposit on the white swatch.

Three experiments were run with four replications each:

White Swatch Treated with Lupasol®, Red Swatch Untreated (WTRU)

White Swatch Untreated, Red Swatch Treated with Lupasol® (WURT)

White Swatch Untreated, Red Swatch Untreated (WURU, Control)

Observations from Experiment:

After several minutes, the color of the water in the experiments varied in their shade of pink. The darkness of the pink was noticeably different with the ranking as follows (BEST TO WORST):

1. WURT—Nearly clear in color, only a barely noticeable pink haze

2. WTRU—Darker than WURT, but only slight pink in color

3. WURU—Very deep pink color much darker than WTRU and WURT

After several hours, the white swatches were removed from the solutions and allowed to dry. Prior to panel grading, the visual observations were as follows: WURT swatches were only slightly pink and results were much better than WURU controls, WTRU were noticeably darker but still appear to be statistically better than WURU control.

Panel:

To best grade the amount of dye locked into the swatches, the twelve white swatches were used.

All twelve swatches were randomly laid out on a table with a new white swatch used as a visual grade of one (clean) and a new red swatch used as a visual grade of ten (fully stained).

The panel was conducted through grading by ten trained panelists who gave each swatch a grade of 1 though 10. Experiments were replicated 3 times each. For comparison standards, an untreated white swatch was assigned a grade of 1 and an untreated red swatch a grade of 10.

The statistical results were calculated with the use of Minitab software.

Results of Statistical Analysis:

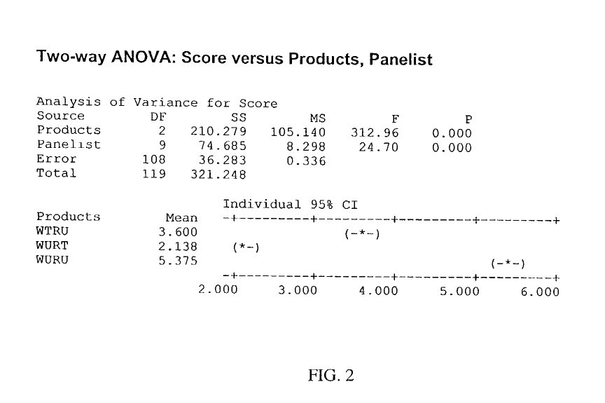

FIG. 2 is a table and graph of results of statistical analysis of the data generated by the experiments. These results demonstrate that regardless of whether the white swatch was treated with Lupasol® or the red one was, the overall amount of dye transfer is significantly reduced compared to the control experiment.

Furthermore, in the red treated swatches, dye transfer was prevented the most and transfer of dye yielded a mean score of 2.138 compared to the amount of dye transferred to the mother liquor and thus the white swatch of 3.600. Even when the white swatches were treated with Lupasol®, the amount of dye transferred is still significantly reduced compared to the control experiment (WURU).

These results can be abstracted to distinguish the DTI and the dye fixative effects. As a DTI, the following Table 1 shows simply WTRU (White Treated, Red Untreated) and WURU (White Untreated, Red Untreated) to represent control. The panel was conducted through grading by ten trained panelists who gave each swatch a grade of 1 though 10. Experiments were replicated 3 times each. For comparison standards, an untreated white swatch was assigned a grade of 1 and an untreated red swatch a grade of 10.

TABLE 1

| SAMPLE | PANEL SCORE |
|---|---|
| WTRU | 3.60 |
| WURU | 5.38 |

95% confidence in difference

UV/Visible Experiment

In another experiment demonstrating the benefits of the invention, the mother liquor from experiments where red and blue swatches were both treated and untreated with Lupasol® were placed in hot water and allowed to soak (as previously described above). After soaking overnight, the mother liquors of all four solutions were collected and uv/visible spectrometry was utilized to quantify the difference in color of the solutions. Table 2 shows the results.

TABLE 2

| | WAVELENGTH | |
|---|---|---|
| | OF | |
| | ABSORPTION | ABSORBANCE |
| SOLUTION | (nm) | (AU) |
| Lupasol ® treated swatch (red) | 525.0 | 0.001 |
| Lupasol ® treated swatch (red) | 667.0 | 0.001 |
| Untreated swatch (red) | 525.0 | 0.055 |
| Untreated swatch (blue) | 667.0 | 0.011 |

These results show that treated swatches transfer barely visible amounts of dye compared to untreated controls. This demonstrates that the swatches treated with Lupasol® are significantly better at holding clothing dyes than untreated controls.

Dye Fixatives

A fifth category comprises dye and finish protectants and color fixative agents. These act by depositing on the fibers comprising the textiles to effectively lock-in dyes and pigments present on the fiber's surface to prevent their loss during soaking and washing processes, as well as subsequent loss from other sources of abrasion experienced during wear. This category includes surface-active polymers, exemplified by materials such as Ciba-Geigy Tinofix CL technology.

Dye fixing agents, or “fixatives”, are well-known, commercially available materials which are designed to improve the appearance of dyed fabric by minimizing the loss of dye from fabrics due to washing. Many dye fixatives are cationic, and are based on various quatemized or otherwise cationically charged organic nitrogen compounds. Fixatives are available under various trade names from several suppliers. Representative examples include: CROSCOLOR PMF (July 1981, Code No. 7894) and CROSCOLOR NOFF (January 1988, Code No. 8544) from Crosfield; INDOSOL E-50 (Feb. 27, 1984, Ref No. 6008.35.84; polyethyleneamine-based) from Sandoz; SANDOFIX TPS, which is also available from Sandoz and is a preferred polycationic fixative for use herein and SANDOFIX SWE (cationic resinous compound), REWIN SRF, REWIN SRF-O and REWIN DWR from CHT-Beitlich GMBH. Another preferred embodiment of the dye fixative of the present invention is Tinofix Eco (TM) by Ciba-Geigy Textile Products Division.

Dye fixing agents suitable for use in the present invention are ammonium compounds such as fatty acid—diamine condensates e.g. the hydrochloride, acetate, metosulphate and benzyl hydrochloride of oleyldiethyl aminoethylamide, oleylmethyl-diethylenediaminemethsulphate, monostearyl-ethylene diaminotrimethylammonium methosulphate and oxidized products of tertiary amines; derivatives of polymeric alkyldiamines, polyamine-cyanuric chloride condensates and aminated glycerol dichlorohydrins. U.S. Pat. No. 5,789,373 issued Aug. 4, 1998 to Baker et al. discusses additional dye fixatives at about column 4 line 34 to about column 5 line 4, and is hereby incorporated herein by reference in its entirety. Another dye fixative made by Alco is an amphoteric (cationic at low pH and nonionic at high pH) biguanide polymer. Use of this compound as a dye fixative is described in U.S. Pat. No. 6,008,316 issued Dec. 28, 1999 to Foster et al. which is hereby incorporated herein by reference in its entirety.

Dye fixatives, traditionally, have been used in textile mills to fix dyes onto fabric before it is sold to clothing manufacturers. Many contain formaldehyde, although the trend is to move away from this chemical. Newer dye fixatives tend to be proprietary cationic polymers. The dye fixatives which are being tested for use in laundry products are the newer types of dye fixatives. The objective is to fix dyes that were either not completely fixed at the mill or were poorly fixed at the mill. These dye fixatives do not exhaust onto fabric in the presence of detergents due to the high level of anionic surfactants in detergents. It will be understood that as the search for molecules effective in the wash in the presence of detergents and surfactants, the present invention will encompass the newer and more effective dye fixatives useful in pre-soak, wash or rinse cycles.

The amount of dye fixing agent to be employed in the composition of the invention is preferably from about 0.001% to about 25% by weight of the composition, more preferably from about 0.002% to about 20% by weight, most preferably about 2.5% by weight of the composition. A preferred embodiment of the color care compositions of the present invention comprises about 2.5% dye fixing agent in anionic systems. This is considered a color fixing or finish protecting effective amount.

It will be understood that Lupasol®, described above, is also a dye fixative, and can also be considered a part of this group of chemicals. As stated above, the results from experiments described above can be abstracted to distinguish the DTI and the dye fixative effects. As a dye fixative, the following Table 3 shows simply WURT (White Untreated, Red Treated) and WURU (White Untreated, Red Untreated) to represent control. The panel was conducted through grading by ten trained panelists who gave each swatch a grade of 1 though 10. Experiments were replicated 3 times each. For comparison standards, an untreated white swatch was assigned a grade of 1 and an untreated red swatch a grade of 10.

TABLE 3

| SAMPLE | PANEL SCORE |
|---|---|
| WURT | 2.14 |
| WURU | 5.38 |

95% confidence in difference

Fabric Lubricating/Softening Agents

A sixth category comprises fabric softening agents. In preferred embodiments, these include silicon-based textile lubricant and textile softening agents that bind or coat textiles to reduce inter-fiber friction and fiber surface friction. This category of component of the composition effectively acts to reduce fabric abrasion during machine agitation, and concomitantly during normal use of the textile, such as during wear. The category comprises effective compounds based on silicon, and include silicon oils, siloxanes, derivatized silicones and derivatized siloxanes, polysilicones, polysiloxanes, aromatic silicon compounds, silanes and derivatized silanes. Examples include BASF Siligin SIN, Dow Corning Q2-5220 and Rhodia Rhodosil TCH-1 textile surface modifiers.

In a preferred embodiment, the lubricant/softening agent as noted above, is a silicone and may include at least one of a polydimethylsiloxane, a polydiorganosiloxane gum or an admixture of a polydiorganosiloxane gum as previously indicated together with a volatile cyclic silicone. Among the simplest silicone materials applicable in the present invention are the polydimethylsiloxanes. Polydimethylsiloxanes have a structure with a repeating dimethylsiloxane unit. The terminal unit (Me3SiO) is the trimethylsiloxy group, however, the polymer may be hydroxy or methoxy endblocked. At low molecular weights, silicones are fluids, and at high molecular weights, they are gums which may be cross-linked to form elastomeric products. The methyl group in a silicone may be substituted by a variety of other substituents including for example, phenyl, vinyl, and hydrogen. Conventional silicones are the trimethylsiloxy, hydroxy, or methoxy terminated polydimethylsiloxanes. Substituents on the silicon consist of methyl groups or oxygen. Termination of the polymer chain prevents viscosity change and other alterations of the physical properties of the silicone polymeric materials. The polydimethylsiloxanes exhibit characteristic properties of low viscosity change with temperature; thermal stability; oxidative stability; chemical inertness; non-flammability; low surface tension; high compressibility; shear stability; and dielectric stability. In resin forming polysiloxanes, some of the methyl groups are hydrolyzable and permit the formation of Si—O—Si cross-links upon heating in the presence of a catalyst, but in the organosilcon fluids and oils, substantially all of the methyl groups are non-hydrolyzable and the fluid is heat stable. The siloxane polymer is generally end-blocked either with trimethylsilyl, hydroxyl, or methoxy groups but other end-blocking groups are also suitable. The polymer can be prepared by various techniques such as the hydrolysis and subsequent condensation of dimethyldihalosilanes, or by the cracking and subsequent condensation of dimethylcyclosiloxanes.

The polydiorganosiloxane gum suitable for use in the present invention are for the most part polydimethylsiloxane gums. The polydiorganosiloxane gums can be represented by an average unit methyl radical, a vinyl radical, a phenyl radical, an ethyl radical or a 3,3,3-trifluoropropyl radical. Small amounts of other groups can be present such as propyl, butyl, hexyl cyclohexyl, beta-phenylethyl, octadecyl and the like; other halogenated monovalent hydrocarbon radicals, such as chloromethyl, bromophenyl, .alpha.,.alpha.,.alpha.-trifluorotolyl, perfluoroheptylethyl, dichlorophenyl and the like; cyanoalkyl; alkoxyl, such as, methoxy, propoxy, ethoxy, hexoxy and the like; ketoxime; halogen; hydroxyl; and acyloxy. The groups which are present in small amounts are considered as incidental and not producing any significant characteristic changes of the polydimethylsiloxane gum.

The polydiorganosiloxane gums suitable for the present invention are essentially composed of dimethylsiloxane units with the other units being represented by monomethylsiloxane, trimethylsiloxane, methylvinylsiloxane, methylethylsiloxane, diethylsiloxane, methylphenylsiloxane, diphenylsiloxane, ethylphenylsiloxane, vinylethylsiloxane, phenylvinylsiloxane, 3,3,3-trifluoropropylmethylsiloxane, dimethylphenylsiloxane, methylphenylvinylsiloxane, dimethylethylsiloxane, 3,3,3-trifluoropropyldimethylsiloxane, mono-3,3,3-trifluoropropylsiloxane, monophenylsiloxane, monovinylsiloxane and the like. The polydiorganosiloxane gums are well known in the art and can be obtained commercially, and are considered to be insoluble polydiorganosiloxanes.

These gums may be used alone as well as in admixture with one or more volatile ingredients such as a cyclic silicone. Volatile cyclic silicones which may be employed are polydimethylcyclosiloxanes exemplary of which are octamethylcyclotetrasiloxane and decamethylcyclopentasiloxane.

The cationic fabric softener compounds of the present invention are preferably quaternary ammonium or imidazolinium compounds having at least one quaternary nitrogen atom in the molecule. The quaternary ammonium compounds are exemplified by the same or different, long chain saturated or unsaturated aliphatic hydrocarbon groups each with from 14 to 26 and preferably 16 to 20 carbon atoms, such groups including halide, nitrate, sulfate, methylsulfate or ethylsulfate. Preferably, such is halide or methylsulfate, most preferably chloride or bromide. The remaining can be straight or branched. Optionally, the hydroxy alkyl groups can include from 1 to 6 moles of ethylene oxide. The long chain aliphatic carbon groups can be linear or branched and derived from fatty acids or fatty amines. Examples of such quaternary ammonium fabric softeners include distearyl dimethylammonium chloride, ditallow dimethylammonium chloride, dioleyl dimethylammonium chloride, ditallow methylhydroxy ethylammonium chloride, ditallow methylhydroxypropyl ammonium chloride and dimyristyl diethyl ammonium bromide. Most preferably, the groups are derived from tallow or hydrogenated tallow. Examples of diquats include JORDAQUAT DIMER 18, and JORDAQUAT DIMER AD trademarked products of the Jordan Chemical Co. Other useful fabric softeners include the imidazolinium-type exemplified by the group consisting of halide, nitrate, sulfate, methylsulfate or ethylsulfate. Preferably, such is halide or ethylsulfate, most preferably chloride or bromide. Exemplary compounds of this type include 1 methyl-1-alkylamidoethyl 1-2-alkylimidazolinium methylsulfate. An example of this compound is manufactured and marketed by the Sherex Chemical Co., Inc., under the Trademark VARISOFT 3690, wherein the alkyls are derived from oleic acid. Also suitable is VARISOFT 222/LT, a methyl bis (oleylamidoethyl) 2-hydroxyethyl ammonium methyl sulfate. Mixtures of any of the foregoing fabric softeners are also suitable.

The fabric softener will be present in a fabric softening-effective amount., i.e., about 0% to about 5% by weight of the composition. Other fabric softener actives are known in the art and are suitable for use with the present invention. These include, for example, alkyl and cyclic amines, and salts thereof, such as those disclosed in U.S. Pat. Nos. 4,661,269 issued to Trinh et al, and 4,661,267 issued to Dekker et al, and substituted amine salts, disclosed in U.S. Pat. No. 4,139,479 issued to Goffinet, the disclosures of which are incorporated herein by reference.

Hardness Sequestrants and Crystal Growth Inhibitors

A seventh category comprises hardness (typically calcium and magnesium and other metals) sequestrants and crystal growth inhibitors. These act by binding to free ions to prevent formation of insoluble compounds and subsequent precipitation onto textiles, as well as binding to any existing nucleating particles or crystal growth sites present on fibers to prevent further deposition of insoluble materials on textiles. While many common detergents and laundry additives contain these materials and would therefore provide some degree of protection, the inhibitors present in the invention would provide an additional benefit in the case of high hardness and builder levels, particularly carbonate salts introduced to the wash, and in addition protect against hardness in the wash water for treatments consisting solely of the current invention without other additives, such as during a presoak and rinse cycle scenario, or a wash with or without a detergent. Examples include phosphate, phosphonates salts and polymeric materials including Alco\Alcosperse 420.

Alcosperse 420, or acrylic-maleic copolymers, are polymers that consist of both acrylic and maleic acid groups (monomers). Each group binds different ions more or less tightly, described mathematically as the binding constant “k”. Each type of ion has its own value for the constant, the higher the “k” value, the greater ratio of bound ions to total ions present. Combining the two acids, which each prefer different cations, ensures that the overall polymer will have a higher binding constant with more cations, therefore more effective against a variety of many different cations than a homopolymer.

Copolymer structures come in different forms. Some are “random”, with the two monomers forming up into chains in any possible way during synthesis. Others are “block” synthesized, with short lengths of one type only of preformed homopolymers allowed to interact. The pattern of the blocks are random, but going from one end of the chain to the other, large contiguous blocks of each type are present, randomly oriented. Control by alternating reactives during synthesis results in a third type—“alternating block copolymers”, formed so that the blocks alternate regularly. Each type of copolymer has advantages appropriate for either or all of sequestration of interfering ions, minerals metals and other atoms, and crystal growth inhibition.

In a preferred embodiment, a composition of the present invention comprises between about 0.001% to about 20% sequestrants and/or crystal growth inhibitor. In a more preferred embodiment, the composition of the present invention comprises between about 0.002% and about 10% sequestrants and/or crystal growth inhibitor. In a most preferred embodiment, the composition of the present invention comprises about 1.5% sequestrants and/or crystal growth inhibitor. This is considered to be a sequestering and crystal growth inhibiting effective amount.

Phosphonates and polyacrylates have been shown to be effective in detergent applications for the prevention of encrustation. Phosphonates can function as crystal growth inhibitors which prevents the growth of insoluble calcium and magnesium compounds at substoichiometric concentrations. Polyacrylates can function as sequestering and dispersing agents, as well as crystal growth inhibitors Some drawbacks associated with phosphonates and polyacrylates are that phosphonates can contribute to eutrophication and polyacrylates have limited biodegradability.

In another preferred embodiment, the crystal growth inhibitor is an organo diphosphonic acid or one of its salts/complexes. The organo diphosphonic acid component is preferably present at a level of from 0.005% to 20%, more preferably from 0. 1% to 10%, most preferably from 0.2% to 5% by weight of the compositions. By organo diphosphonic acid it is meant herein an organo diphosphonic acid which does or does not contain nitrogen as part of its chemical structure. This definition therefore includes the organo amino phosphonates, which may be included in compositions of the invention as heavy metal ion sequestrants. The organo diphosphonic acid component may be present in its acid form or in the form of one of its salts or complexes with a suitable counter cation and reference hereinafter to the acid implicitly includes reference to said salts or complexes. Preferably any salts/complexes are water soluble, with the alkali metal and alkaline earth metal salts/complexes being especially preferred. The organo diphosphonic acid is preferably a C₁-C₄ diphosphonic acid, more preferably a C₂ diphosphonic acid, such as ethylene diphosphonic acid, or most preferably ethane 1-hydroxy-1, 1-diphosphonic acid (HEDP).

Amino carboxylates useful as chelating agents herein include ethylenediaminetetraacetates (EDTA), N-hydroxyethylethylenediaminetriacetates, nitrilotriacetates (NTA), ethylene diamine tetraproprionates, ethylene diamine-N,N′-diglutamates, 2-hydroxypropylenediamine-N,N′-disuccinates, triethylenetetraaminehexacetates, diethylenetriaminepentaacetates (DETPA), and ethanoldiglycines, including their water-soluble salts such as the alkali metal, ammonium, and substituted ammonium salts thereof and mixtures thereof.

Amino phosphonates are also suitable for use as chelating agents in the compositions of the invention when at least low levels of total phosphorus are permitted in detergent compositions, and include ethylenediaminetetrakis (methylene phosphonates), diethylenetriamine-N,N,N′,N″,N″-pentakis(methane phosphonate) (DETMP) and 1-hydroxyethane-1,1-diphosphonate (HEDP). Preferably, these amino phosphonates do not contain alkyl or alkenyl groups with more than about 6 carbon atoms.

The chelating agents are typically used in the preferred aqueous compositions to provide levels in aqueous solution of from about 2 ppm to about 50 ppm. The preferred EDDS chelator used herein (also known as ethylene diamine-N,N′-disuccinate) is the material described in U.S. Pat. No. 4,704,233, incorporated herein by reference. As disclosed, EDDS can be prepared using maleic anhydride and ethylene diamine. Preferred biodegradable isomers of EDDS can be prepared by reacting L-aspartic acid with 1,2-dibromoethane. The EDDS has advantages over other chelators in that it is effective for chelating heavy metal cations, is available in a biodegradable form, and does not contain phosphorus. The EDDS employed herein as a chelator is typically in its salt form, i.e., wherein one or more of the four acidic hydrogens are replaced by a water-soluble cation M, such as sodium, potassium, ammonium, triethanolammonium, and the like. As noted before, the EDDS chelator is also typically used in the present compositions and methods at levels which will provide from about 2 ppm to about 50 ppm for periods from 1 minute up to several hours' soaking.

As can be seen from the foregoing, a wide variety of chelators can be used herein. Indeed, simple polycarboxylates such as citrate, oxydisuccinate, and the like, can also be used, although such chelators are not as effective as the amino carboxylates and phosphonates, on a weight basis. Accordingly, usage levels may be adjusted to take into account differing degrees of chelating effectiveness. The chelators herein will preferably have a stability constant (of the fully ionized chelator) for copper ions of at least about 5, preferably at least about 7. Typically, the chelators will comprise from about 0.1% to about 15%, more preferably from about 0.1% to about 10%, and most preferably from about 0.5% to about 10%, by weight of the compositions herein. Preferred chelators include DETMP, DETPA, NTA, EDDS and mixtures thereof.

Chlorine and Oxygen Neutralizers and Scavengers

An eighth category of element in the fabric care composition of the present invention comprises a combination of active chlorine neutralizers and active oxygen scavengers that act to neutralize species with oxidation potential (oxidants) present in the wash water. Sources of oxidants include active chlorine in tap water resulting from municipal water purification and peroxide species introduced by detergents and laundry additives that can contribute to dye fading. Active chlorine neutralizers consist of mild reducing agents that chemically reduce active chlorine to an inactive form. Active oxygen scavengers consist of mild reducing agents that either bind with oxidants or catalytically decompose oxidants in the wash liquor during use. Examples include sodium thiosul fate (a reductant), butylated hydroxytoluene and butylated hydroxyani sole (BHT and BHA, antioxidants) and Catalase enzyme (biocatalytic agent). In a preferred embodiment, the introduction of a chlorine scavenger such as a hydroxyamine compound is added to the fabric care composition to react with residual chloride or chlorine in the wash.

Such compositions according to the present invention provide about 0.1 ppm to about 40 ppm, preferably from about 0.2 ppm to about 20 ppm, and more preferably from about 0.3 ppm to about 10 ppm of chlorine scavenger to an average laundry bath. Suitable levels of chlorine scavengers in the compositions of the present invention range from about 0.001% to about 5%, preferably from about 0.002% to about 2.5%, most preferably about 0.3%, by weight of total composition. This is considered a chlorine and/or oxygen scavenging effective amount. Non-limiting examples of chlorine scavengers include primary and secondary amines, including primary and secondary fatty amines; ammonium salts, e.g., chloride, sulfate; amine-functional polymers; amino acid homopolymers with amino groups and their salts, such as polyarginine, polylysine, polyhistidine; amino acid copolymers with amino groups and their salts; amino acids and their salts, preferably those having more than one amino group per molecule, such as arginine, histidine, not including lysine reducing anions such as sulfite, bisulfite, thiosulfate, nitrite; antioxidants such as ascorbate, carbamate, phenols; and mixtures thereof Ammonium chloride is a preferred inexpensive chlorine scavenger for use herein. Other useful chlorine scavengers include water-soluble, low molecular weight primary and secondary amines of low volatility, e.g., monoethanolamine, diethanolamine, tris(hydroxymethyl)aminomethane, hexamethylenetetramine. Suitable amine-functional chlorine scavenger polymers include: water-soluble polyethyleneimines, polyamines, polyvinylamines, polyamineamides and polyacrylamides. The preferred polymers are polyethyleneimines, the polyamines, and polyamineamides. Preferred polyethyleneimines have a molecular weight of less than about 2000, more preferably from about 200 to about 1800.

Thickness and Viscosity Modifiers

A ninth category comprises materials to modify the elastic and viscous phase properties of the compositions. These include thickening agents and viscosity modifying additives, which provide for a product with acceptable pouring and handling characteristics during dispensing. These actives also contribute to improved product stability and resistance to phase separation and settling of dispersed materials in the composition through elastic modification of the composition phase properties. Included in this category are adjuncts, exemplified by soluble ionic salts, organic salts and hydrotropes that aid viscosity modifying additives through control of solution ionic strength and molar activity effects. Examples include naturally derived biopolymers such as starch, xantham gum, gum Arabica, derivatized biopolymers such as methyl- and ethyl-cellulose and synthetic polymers such as polyvinyl alcohol.

Other thickeners that are effective in the present invention include organic, nonionic, water soluble and water swellable polymers such as polyethoxylated urethanes and cellulose ethers such as hydroxyethyl cellulose, methylcellulose, and hydroxypropylmethyl cellulose.

Compositions of the present invention preferably contain a polymer thickening agent or polymer mixture which are capable of suspending relatively large size particles while remaining relatively pourable. Specifically, the polymer or mixture are selected to form a continuous, interlocking network system. It is well known that polymers that require at least some ionic species to be present as a prerequisite for gel formation are susceptible to destabilization by surfactant whether formed as a continuous network or a non-continuous network of gel “bits”. Thus, a polymer or polymer mix capable of forming a network (e.g., in the presence of electrolyte) can be stable in various compositions or light or heavy duty liquid, liquid-gel or gelled detergent compositions with high surfactant concentration (i.e., greater than 20%, preferably 21% to 85%) if prepared in the proper way. This is the case even with some ionic surfactants.

In general, the polymer or polymer mixture forming the modified viscosity or continuous network system of the invention will be of natural origin, specifically one or more polysaccharides. However, it is possible that the polymer, or one or more polymers in a mixture of polymers, might be a chemically modified natural polymer such as a polysaccharide which has been chemically treated to provide or alter substituent groups thereon. It is also conceivable that a polymer mixture might contain a synthetic polymer together with a natural polymer. Usually however, the polymer which is used will include a polysaccharide chain of natural origin. Examples of gums which may be used are various commercial gums which may be characterized as (1) marine plant; (2) terrestrial plants; (3) microbial polysaccharides and (4) polysaccharide derivatives. In addition, gums may include those derived form animal sources (e.g., from skin and/or bones of animals) such as gelatin. Examples of nonionic plant gums include agar, alginates, carrageenan and furcellaran. Examples of terrestrial plant gums include guar gum, gum arabic, gum tragacanth, karaya gum, locust bean gum and pectin. Examples of microbial polysaccharides include dextran, gellan gum, rhamsan gum, welan gum, xanthan gum. Examples of polysaccharide derivatives include carboxymethylcellulose, methyl hydroxypropyl cellulose, hydroxypropyl cellulose hydroxyethyl cellulose, propylene glycol alginate, hydroxypropyl guar and modified starches.

A particularly preferred gum for forming a continuous network is xanthan gum (e.g., Keizan T from Monsanto Company). Another gum forming such continuous network includes gellan gum. Because of the process for pre-swelling prior to contact with surfactant and addition of substantially all nonionic species before ionic species, the continuous network formed is stable to surfactant. In another embodiment, the suspending polymer or polymers can be used in combination with cationic polymer such as for example, cationic guar gum (e.g., Jaguar 162 from Rhone Poulenc), polyquaternium 10 (e.g., Ucare Polymer JR 30M from Americhol Corp.). Ratio is at 5:1 to 100:1 anionic gum to cationic polymer. Suspending polymer/polymer mixtures are generally used in an amount of 0.01 to 3% total polymer, preferably between 0.1 and 0.6% total polymer. In addition to the continuous gum network, additional thickening agent such as small concentration of other types of structuring agent, including gums may be used. Examples of such accessory structurants include polysaccharide derivatives such as carboxymethylcellulose, methyl hydroxy propyl cellulose etc.

Bio-Preservatives

A tenth category comprises formula preservatives, which provide anti-microbial, anti-bacterial and anti-fungal protection to the finished composition and its key components during processing and storage. These actives contribute to improved product stability and maintenance of activity, as well as prevention of undesirable microbial growth during extended storage. Examples include Integra 44, Proxel GXL and Dowicil 75 antimicrobials.

The term “antibacterial agent” as used herein refers to materials which prevent or inhibit the growth of bacteria on an inanimate surface. Among the known antibacterial agents which are suitable for the present invention are phenolic and xylenol antibacterial agents. Two are particularly preferred: PCMX (para chlorometa xylenol) and Triclosan (2,4,4′-trichloro-2′-hydroxy diphenyl ether). These are normally solid at room temperature and have melting points of about 115 .degree. C. for PCMX and about 50 .degree. C. for Triclosan. Other useful antibacterial agents include 3,4,4′-trichloro carbanilide, DTBBP (2,t-butyl-4-cyclohexylphenol) and other suitable antibacterial compounds containing phenol groups. Also useful herein are oxidants such as sodium perborate, activated perborate, percarbonate and the like. Less preferred for the present invention are those antibacterial agents such as quaternary ammonium compounds which may be incompatible with certain detergent ingredients such as anionic surfactants.

pH Modifiers and Buffers

An eleventh category comprises aqueous pH and buffering agents, which help to maintain an acceptable product pH during storage. These actives ensure maintenance of conditions favorable to enzyme stability, since enzymes are commonly susceptible to undesirable changes in formula pH. Further, these actives provide phase stability by preventing precipitation and/or separation of other actives that are sensitive to changes in solution pH resulting from absorption of atmospheric gases such as carbon dioxide over time. Examples include mono-, di- and tri-ethanolamine and their hydrochloride salts, ethanolamine derivatives. Mineral acids such as hydrochloric acid, sulftric acids and nitric acid are examples of suitable pH adjusters, in addition to organic derived acids such as sulfonic acid, sulfamic acid and citric acid.

Miscellaneous Components

Other miscellaneous actives featured in the inventive compositions comprise materials that provide an acceptable aesthetic appeal to the consumer. These include aesthetic and appealing dyes and fragrances, to provide a suitable colored appearance and odor to the product compositions during handling and use. U.S. Pat. No. 4,579,677 issued Apr. 1, 1986 to Hooper et al. is incorporated herein by reference in its entirety.

In a preferred embodiment, humectants or other materials which promote the retention of fluid, optionally in the form of a gel block, can be added to the color care composition of the present invention. Such gel blocks are matrix based support systems for providing slow, continuous, controlled and uniform results.

It has been found that in order for an aesthetic dy or fragrance to be effective and have value in the present invention, these components of the color care composition must be selected carefully. Based particularly on the foregoing, it will be obvious to those skilled in the art that selection of these components should ensure lack of adverse reaction or other deleterious effect on the overall fabric care composition. Thus, it has been found that aesthetic dyes in particular must be selected to minimize interaction with any dye fixative of fixing agent, sequestering agents, etc. Likewise, any UV blockers, FWAs, etc. must be selected to avoid binding by any dye scavenger used in the composition.

Further miscellaneous actives comprise process and handling aids, added to the formula during mixing, ingredient combination, and bottle filling and recovery operations common to industrial processes. These include anti-foaming agents, foam reducing agents, wetting agents and process oils which function to reduce foaming, frothing and bubble retention in the product during manufacturing and processing operations. An example is Dow Corning 1500 Antifoam.

Methods of Use

The invention comprises color care compositions and methods of use to provide protection to textiles from fading and appearance change, in addition to fiber and color maintenance during consumer treatment of clothing and textiles. The compositions have several key performance actives that target common dye fading and textile damaging mechanisms experienced during the wash and dry processes, and during wear and exposure to the elements.

In a preferred embodiment, the present invention is most useful as a color and care composition for pre-soaking or pre-treating fabrics. In this first embodiment, the method of the present invention includes adding a predetermined volume or amount of the composition of the present invention to water or other cleaning solution. This pre-soak or pre-treatment is especially important for setting or fixing dyes, etc. The methods of use provide for introduction of selected compositions in a hand-soak or machine pre-soak situation.

In another preferred embodiment of the method of use of the present invention, the composition is added to a washing cycle, along with a laundry or fabric detergent composition or solution. In this mode, the care composition of the present invention is most simple to use. In the main wash cycle, the present invention can be used either alone or in combination with a regular detergent or laundry additive.

In another preferred embodiment, the present invention is a rinse additive, introduced either alone or in combination with a fabric softener. In addition, further compositions and methods of use of the present invention employ a dispensing device which provides for repeated and automatic dispensing of an effective dose of this composition through each machine cycle.

### EXAMPLE(S) OF INVENTION

### Example 1

A first specific example of a fabric care composition of the present invention follows, with the most preferred composition ranges indicated in addition to the role of each ingredient:

| | | Active | |
|---|---|---|---|
| | | Range | Best |
| Ingredient (#) | Company - Material - Function | (wt %) | Example (wt %) |
| (1) | Water | 50-99% | app. |
| | | | 82.7% |
| (2) | 3V - Uvasorb MET C - UV Absorber | 0-10% | 0.05% |
| (3) | 3V - Uvasorb HA77 - Light Stabilizer | 0-10% | 0.45% |
| (4) | ISP- Triethanolamine - Chlorine | 0.1-5% | 0.5% |
| | scavenger, pH buffer | | |
| (5) | ISP - Sulfuric Acid - pH adjuster | 0-5% | 0.1% |
| (6) | ALCO - Alcopherse 420 - Sequestrant | 0-20% | 1.5% |
| | and crystal growth inhibitor | | |
| (7) | ALCO - Dye Fixative agent | 0-20% | 2.5% |
| (8) | Union Carbide - Tergitol TMN-3 - | 0-10% | 1.1% |
| | Surfactant and UV solubilizer | | |
| (9) | Union Carbide - Tergitol TMN-10 - | 0-50% | 8.9% |
| | Cosurfactant* | | |
| (10) | NOVO - Carezyme ® Enzyme - | 0-5% | 0.745% |
| | cellulase enzyme | | |
| (11) | Keltrol - Technical Xantham Gum - | 0-5% | 0.15% |
| | thickening agent | | |
| (12) | ISP - Sodium Thiosulfate - Chlorine | 0-1% | 0.3% |
| | reducing agent | | |
| (13) | Generic - Dye - Product aesthetics | 0-1% | 0.002% |
| (14) | Fragrance Oil - Product aesthetics | 0-1% | 0.30% |
| (15) | Preservative - Anti-bacterial and | 0-1% | 0.10% |
| | anti-fungal agent | | |
| (16) | Dow AF1500 - Antifoam - Process fill | 0-0.001% | 0.01% |
| | or other processing aid | | |
| | | TOTAL | 100% |

*Replaceable with Surfonic 15-S-7.)

### Example 2

Another specific example of a fabric care composition of the present invention follows, in this case the composition formulated particularly for use as a regular laundry wash cycle additive, with the most preferred composition ranges indicated in addition to the role of each ingredient:

| | | Active | Best |
|---|---|---|---|
| Ingredient (#) | Company - Material - Function | Range (wt %) | Example (wt %) |
| (1) | Water | 50-99% | 82.76% |
| (2) | 3V - Uvasorb MET C - UV Absorber | 0.001-10% | 0.03% |
| (3) | 3V - Uvasorb HA77 - Light Stabilizer | 0.001-10% | 0.3% |
| (4) | ISP - Triethanolamine - Chlorine | 0.1-5% | 0.6% |
| | scavenger, pH buffer | | |
| (5) | ISP - Sulfuric Acid - pH adjuster | 0-5% | 0.1% |
| (6) | BASF - Sokalan HP-53 - Anti dye | 0-20% | 4.1% |
| | redeposition polymer | | |
| (7) | ALCO - Alcosperse 420 - Sequestrant | 0-20% | 1.48% |
| | and crystal growth inhibitor | | |
| (8) | Union Carbide - Tergitol TMN-3 | 0-50% | 1% |
| | Surfactant | | |
| (9) | Union Carbide - Tergitol TMN-10 | 0-50% | 8% |
| | Surfactant | | |
| (10) | FMC - Sodium Chloride - Ionic | 0-10% | 0.1% |
| | strength adjustor | | |
| (11) | Keltrol - Technical Xantham Gum - | 0-5% | 0.15% |
| | thickening agent | | |
| (12) | ISP - Sodium Thiosulfate - Chlorine | 0-1% | 0.3% |
| | reducing agent | | |
| (13) | Acid Dye - Product aesthetics | 0-1% | 0.002% |
| (14) | Fragrance Oil - Product aesthetics | 0-1% | 0.3% |
| (15) | Preservative - Anti-bacterial and | 0-1% | 0.1% |
| | anti-fungal agent | | |
| | | TOTAL | 100% |

### Example 3

Yet another specific example of a fabric care composition of the present invention follows, in this case the composition formulated particularly for use as a rinse additive, with the most preferred composition ranges indicated in addition to the role of each ingredient:

| Ingredient | Company - Material - | Active | Best |
|---|---|---|---|
| (#) | Function | Range (wt %) | Example (wt %) |
| (1) | Water | 0-50% | 94.018% |
| (2) | 3V - Uvasorb MET C - UV Absorber | 0.001-10% | 0.05% |
| (3) | 3V - Uvasorb HA77 - Light Stabilizer | 0.001-10% | 0.45% |
| (4) | ISP - Triethanolamine - Chlorine | 0.1-5% | 0.6% |
| | scavenger, pH buffer | | |
| (5) | ISP - Sulfuric Acid - pH adjuster | 0-1% | 0.1% |
| (6) | ALCO - Alcosperse 420 - Sequestrant | 0-20% | 1.48% |
| | and crystal growth inhibitor | | |
| (7) | CIBA - Tinofix CL - Dye Fixative agent | 0-20% | 2.5% |
| (8) | ISP - Sodium Thiosulfate - Chlorine | 0-1% | 0.3% |
| | reducing agent | | |
| (9) | Acid Dye - Product aesthetics | 0-1% | 0.002% |
| (10) | Fragrance Oil - Product aesthetics | 0-1% | 0.5% |
| | | TOTAL | 100% |

It will be understood that with regard to the formulations comprising both a dye fixative agent as well as an anti dye redeposition agent, either one or both of these agents may be useful, desirable or necessary, depending on the particular application. It will be understood, therefore, that it is not necessary to utilize both a dye fixative agent as well as an anti dye redeposition agent in a given formulation of the present invention, but either one or the other or both may very well be used.

Experimental Results

Table 4 shows the key contributors to textile appearance change. As shown, the first five (5) causes of fading are the most important causes of fading.

TABLE 4
Key Contributors to Textile Appearance Change

| | | % Garments |
|---|---|---|
| | | Susceptible to |
| | Fading | Fading |
| Cause of Fading | Mechanism | Mechanism |
| Light exposure | Dye and finish | 56% |
| | damage due to | |
| | UV radiation | |
| Abrasion of Color | Dye and pigment | 56% |
| | loss due to | |
| | abrasion during | |
| | wash and wear | |
| Abrasion of | Fuzz and pills | 38% |
| Fibers | caused by | |
| | abrasion during | |
| | wash and wear | |
| Bleeding | Fading due to | 5% |
| | dye loss during | |
| | wash | |
| Dye Transfer | Dye transfer onto | 50% |
| | other clothes | |
| | during wash | |
| Tap Water | Chlorine in tap | 5% |
| Bleaching | water causing | |
| | fading | |
| Detergents | Oxidants, | Detergent |
| | activators and | Dependent |
| | surfactants | |
| | causing fading | |
| Yellowing | FWA | FWA dependent |
| | degradation due | |
| | to UV radiation | |
| Encrustation | Hard water plus | Detergent |
| | carbonate | Dependent |
| | deposition | |
| | causing graying | |

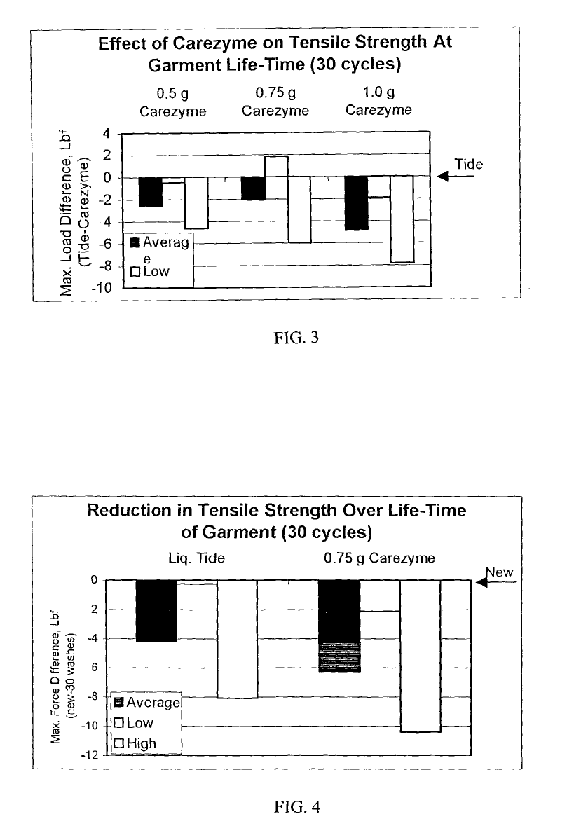

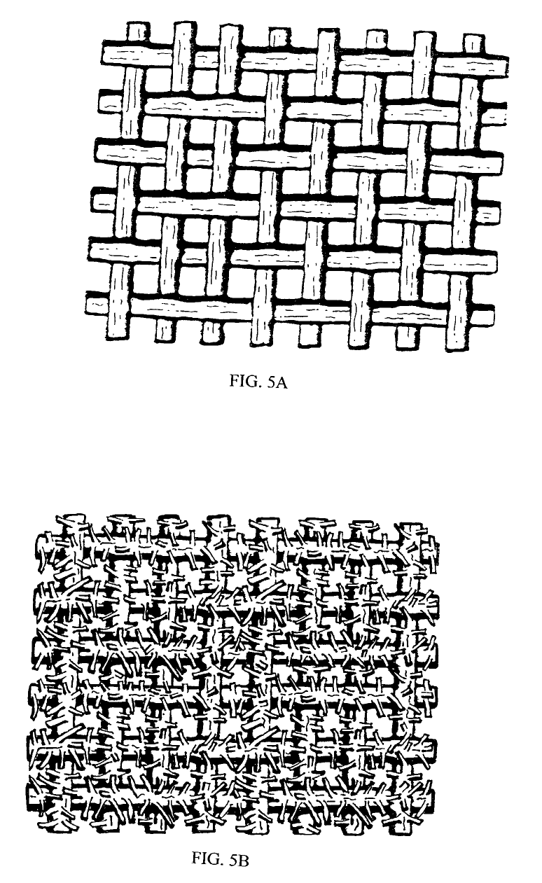

FIG. 3 is a representative graph of experimental data showing the effect of Carezyme® cellulase on tensile strength of fabric. FIG. 4 is a representative graph of experimental data showing the reduction in tensile strength of fabric after treatment with Carezyme® cellulase.

As described above, cellulase-containing compounds, including Carezyme®, are generally known for not destroying bulk cotton while being able to remove fuzz and pills. In cases where high levels of cellulase are desired to achieve fuzz removal in very few wash cycles, it was found that the tensile strength loss becomes more important. Washes were performed under worst-case conditions for cellulase activity. A liquid clothes and fabric cleaning detergent with trade name Tide® Liquid (Proctor & Gamble Company) was used as a non cellulase-containing, common and commercially available detergent standard. The conditions used were warm water (higher activity of cellulase enzyme than cold water) with Tide® Liquid, optimal pH level for cellulase activity (about 9), 100% cotton (most susceptible to damage), and lifetime of garment (30 cycles). FIG. 3 shows the difference between the tensile strength of fabric washed 30 times in Tide® Liquid, which provides a “zero line”, standard or basis, and the tensile strength of fabric washed 30 times in Tide® Liquid plus varying amounts of Carezyme® added to the wash. FIG. 4 compares the tensile strength of cotton flags washed 30 times with the tensile strength of new cotton flags. From these studies, it was found that the Carezyme® level should be below about 1.0 gram per use, and preferably 0.75 grams/use or less, in order to prevent significant fabric damage in the washes where fabric damage is most likely to occur for colored clothing.

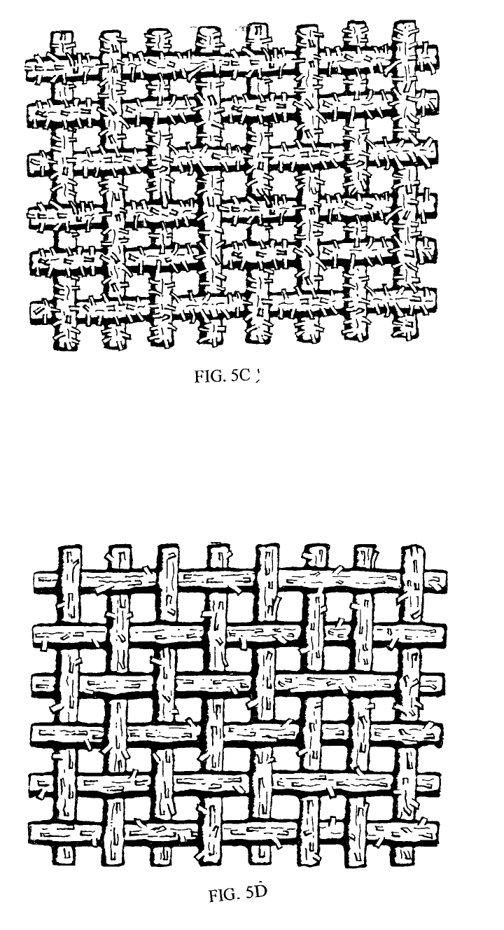

FIG. SA is a representative illustration of a woven cellulose-containing fabric under magnification showing individual woven threads in essentially new condition. FIG. 5B is a representative illustration of a woven cellulose-containing fabric under magnification showing individual woven threads after substantial wear and abrasion has resulted in pilling. Woven threads have become broken and/or delaminated into individual filaments. It will be understood that upon de-lamination and fuzzing, pilling can also occur.

FIG. 5C is a representative illustration of a woven cellulose-containing fabric under magnification showing fabric after treatment with cellulase enzyme. As shown, most of the damaged cellulose filaments have been removed or shortened by enzymatic action, resulting in visible reduction of pilling and wear. FIG. 5D is a representative illustration of a woven cellulose-containing fabric under magnification showing fabric after repeated treatments with cellulase enzyme. After repeated treatments with cellulase enzyme, nearly all of oi the damaged cellulose filaments have been removed by enzymatic action, thus resulting in substantial restoration of the fabric appearance.

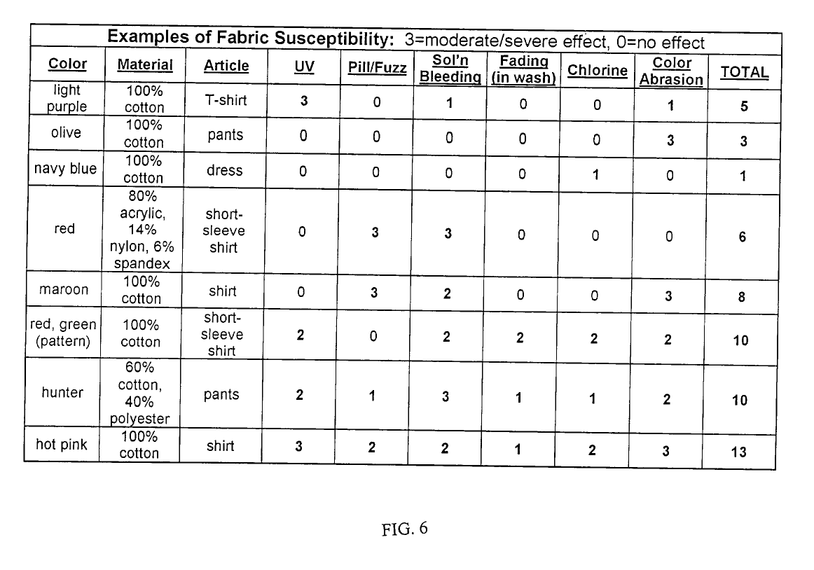

FIG. 6 is a table of experimental data showing examples of fabric susceptibility to various modes of color and quality loss. It will be noted that of clothes that faded during the washing process, 35% were positively affected by using the color care composition described herein. When additionally exposed to sunlight, 17% of clothes that faded were positively affected. Visual grading was used to determine fabric susceptibilities and fading results. A 4-point scale was used which indicates how much fading a panel member sees, with “0” indicating no fading and “3” indicating moderate/severe fading. Thus, based upon the fabric susceptibility data it has been shown that use of only one active in a cleaning formulation does not reduce fading of clothing significantly, and that the present invention does.

Unless defined otherwise, all technical and scientific terms used herein have the same meaning as commonly understood by one of ordinary skill in the art to which the present invention belongs. Although any methods and materials similar or equivalent to those described can be used in the practice or testing of the present invention, the preferred methods and materials are now described. All publications and patent documents referenced in the present invention are incorporated herein by reference.

While the principles of the invention have been made clear in illustrative embodiments, there will be immediately obvious to those skilled in the art many modifications of structure, arrangement, proportions, the elements, materials, and components used in the practice of the invention, and otherwise, which are particularly adapted to specific environments and operative requirements without departing from those principles. The appended claims are intended to cover and embrace any and all such modifications, with the limits only of the true purview, spirit and scope of the invention.

We claim:

1. A liquid, liquid-gel or gelled fabric care composition comprising:
(a) optionally, an enzymatically effective amount of one or more fabric care enzymes, the fabric care enzymes effective for aiding in preventing pilling and fuzzing of fabric fibers during the wash process;
(b) a UV protecting effective amount of one or more UV protectants, the one or more UV protectants for brightening and preventing light caused photo fading or other damage to fabrics, fabric dyes and fabric finishes, including fluorescent whiteners, and pigments;
(c) optionally, an active, dispersing, emulsifying and/or solubilizing effective amount of a surface active dispersing, emulsifying and/or solubilizing agent, the surface active dispersing, emulsifying and/or solubilizing agent principally comprised of surfactants, co-surfactants, hydrotropes and solvents selected to solubilize or stabilize the composition;
(d) a dye-transfer inhibiting and anti-redeposition effective amount of one or more dye-transfer inhibitors, anti-redeposition agents or dye sequestrants, the one or more dye-transfer inhibitors, anti-redeposition agents or dye sequestrants to prevent re-deposition of dyes which have become transient from other fabrics during the washing process;
(e) a color fixing or finish protecting effective amount of a dye, pigment and fabric color fixative or finish protectant, the dye, pigment and fabric color fixative or finish protectant to lock-in dyes and pigments to prevent their loss during soaking or washing;
(f) optionally, a lubricating or softening effective amount of a textile lubricant and/or softening agent, the textile lubricant and/or softening agent to coat the textiles and reduce inter-fiber and fiber surface friction;
(g) optionally, a sequestering and crystal growth inhibiting effective amount of hardness and metal ion sequestrants and crystal growth inhibitors and anti-encrustation agents, the hardness and metal ion sequestrants and crystal growth inhibitors to bind free ions to prevent formation of insoluble precipitate compounds;
(h) optionally, a chlorine and/or oxygen scavenging effective amount of one or more chlorine and/or active oxygen scavengers or neutralizers which act to neutralize oxidizing agents, i.e., those species with oxidation potential; and
(i) optionally, one or more chemicals from the following: handling, storage, processing agents to modify elastic and viscous phase properties, anti-foaming or frothing agents, anti-microbial, anti-bacterial or anti-fungal agents, pH buffer, adjustment and/or modification, as needed, aesthetic dyes and/or fragrances.

2. A liquid, liquid-gel or gelled composition for use in fabric care, the liquid, liquid-gel or gelled composition comprising the following:
(a) about 0.001% to about 5% by weight of one or more fabric care enzymes, the fabric care enzymes effective for aiding in preventing pilling fuzzing, staining and other deterioration of fabric fibers during the wash process;
(b) about 0.001% to about 20% by weight of one or more UV protectants, the one or more UV protectants for brightening and preventing light caused photo fading or other damage to fabrics;
(c) about 0.001% to about 60% by weight of one or more surface active dispersing, emulsifying and/or solubilizing agent, the one or more surface active dispersing, emulsifying and/or solubilizing agent principally comprised of surfactants, co-surfactants, hydrotropes and solvents selected to solubilize or stabilize the composition;
(d) about 0% to about 20% by weight of one or more dye-transfer inhibitors, anti-redeposition agents or dye sequestrants, the one or more dye-transfer inhibitors, anti-redeposition agents or dye sequestrants to prevent re-deposition of dyes which have become transient from other fabrics;
(e) about 0% to about 20% by weight of one or more dye, pigment and fabric color fixative or finish protectant, the dye, pigment and fabric color fixative or finish protectant to lock-in dyes and pigments to prevent their loss in quantity or quality during soaking or washing;
(f) about 0% to about 5% by weight of one or more textile lubricant and/or textile softening agent, the lubricant and/or textile softening agent to coat the textiles and reduce inter-fiber and fiber surface friction;
(g) about 0.001% to about 20% by weight of one or more hardness and metal ion sequestrants and crystal growth inhibitors and anti-encrustation agents, the hardness and metal ion sequestrants and crystal growth inhibitors and anti-encrustation agents to bind free ions to prevent formation of insoluble precipitate compounds;
(h) about 0.001% to about 6% by weight of one or more chlorine and/or active oxygen scavengers or neutralizers which act to neutralize oxidizing agents, i.e., those species with oxidation potential; and
(i) about 0% to about 8% by weight one or more chemicals from the following: handling, storage, processing agents to modify elastic and viscous phase properties, antifoaming or frothing agents, anti-microbial, anti-bacterial or anti-fungal agents, pH buffer, adjustment and/or modification, as needed, aesthetic dyes and/or fragrances; and
(j) balance water or one or more other organic or other solvents.

3. The fabric care composition of claim 2 comprising about 0.002% to about 1% by weight of one or more fabric care enzymes.

4. The fabric care composition of claim 2 comprising about 0.625% by weight of one or more fabric care enzymes.

5. The fabric care composition of claim 2 in which the one or more fabric care enzymes is selected from the following: cellulase, hydrolase, amylase, protease, esterase.

6. The fabric care composition of claim 2 in which the one or more fabric care enzymes includes cellulase.

7. The fabric care composition of claim 6 in which the cellulase is a monocomponent cellulase.

8. The fabric care composition of claim 6 in which the cellulase comprises endoglucanase.

9. The fabric care composition of claim 6 in which the cellulase comprises a variant of a 43 kD endoglucanase derived from Humicola insolens, DSM 1800.

10. The fabric care composition of claim 2 having a pH between about 7.0 and about 9.0.

11. The fabric care composition of claim 2 having a pH about 8.0.

12. The fabric care composition of claim 2 comprising about 0.002% to about 1.0% by weight of one or more UV protectants.

13. The fabric care composition of claim 2 comprising about 0.5% by weight of one or more UV protectants.

14. The fabric care composition of claim 2 in which the one or more UV protectants comprise a UV absorbing material.

15. The fabric care composition of claim 14 in which the UV absorbing material is selected from one or more of the following: 2-hydroxy-4-methoxyphenyl phenyl methanone, 2-ethyl hexylester 2-cyano-3,3,-diphenyl acrylate, methylene bis-benzotriazolyl tetramethylbutylphenol, bis-ethylhexylphenol methoxyphenyl triazine, diethylhexyl naphthalate, octyl salicylate, butyloctyl salicylate, benzophenone-2, benzophenone-9, includes octocrylene, 4-methylbenzylidene camphor, phenylbenzimidazole sulfonic acid, octyl methoxycinnamate, octyl dimethyl paraaminobenzoic acid, benzophenone-4, menthyl anthrailate and isoamyl P(note=para)-methoxysynecinnamate.

16. The fabric care composition of claim 2 in which the one or more UV protectants comprises a fluorescent whitening agent or optical brightener.

17. The fabric care composition of claim 16 in which the one or more UV protectants comprises one or more of the following: stilbene, biphenyl stilbene, coumarin, quinolone, biphenyl pyrazoline and a combination of benzoxazole or benzimidazole with conjugated systems, 4,4′-bis(triazinylamino)-stilbene-2,2′-disulfonic acids, 4,4′-bis-(v-triazole-2-yl)-stilbene-2,2′-disulfonic acids, stilbenyl-napthotriazoles, 4,4′-distyrl-biphenyls, pyrazolines, coumarins, quinolones, bis-(benzimidazole-2-yl)-derivatives, and 2-styryl-benzoxazoles and -napthoxazoles, dibenzoylmethane compounds which provide broad spectrum UV (both UVA and UVB) protection and 4-tert-butyl-4′methoxydibenzoylmethane, stilbene derivatives, styrylnaphthalene brighteners and their derivatives and styrene brighteners and their derivatives, disodium salt of 2,2-(4,4′-biphenylene divinylene)dibenzenesulfonic acid, alkaline earth, alkali metal, zinc, and other multivalent salts (such as the cations of the metals of Groups IIIA and of groups comprising the transition metals of the Periodic Table of the Elements).

18. The fabric care composition of claim 2 in which the one or more UV protectants comprise free-radical scavengers and/or hindered amine light stabilizers to prevent damage from free-radicals generated during irradiation.

19. The fabric care composition of claim 18 in which the free-radical scavengers and/or hindered amine light stabilizers comprises one or more of the following: butylated hydroxytoluene (BHT), decanedioic acid, bis (2,2,6,6-tetramethyl-4-piperidinyl) ester.

20. The fabric care composition of claim 2 in which the one or more UV protectants comprise a combination of (1) UV absorbers, fluorescent whitening agents or optical brighteners and (2) a free-radical scavenger or hindered amine light stabilizer to prevent damage from free-radicals generated during the irradiation of fabric with UV light.

21. The fabric care composition of claim 2 comprising about 0.002% to about 20% by weight of the one or more surface active dispersing, emulsifying and/or solubilizing agents.

22. The fabric care composition of claim 2 comprising about 10% by weight of the one or more surface active dispersing, emulsifying and/or solubilizing agents.

23. The fabric care composition of claim 2 in which the one or more surface active dispersing, emulsifying and/or solubilizing agents are nonionic surfactants and cosurfactants, anionic or combinations of anionic and nonionic surfactants, cationic surfactants and co-surfactants, combinations of cationics with nonionic surfactants, amphoteric or zwitterionic surfactants, or hydrotropes.

24. The fabric care composition of claim 23 in which the one or more surface active dispersing, emulsifying and/or solubilizing agents includes a negatively charged water solubilizing group.

25. The fabric care composition of claim 23 in which the nonionic surfactant is one selected from the following: modified polysiloxanes, alkoxylated alcohols, alkoxylated phenol ethers, glycosides, trialkyl amine oxides, other “semi-polar” nonionics, alkoxylated dimethylsiloxane, alkoxylated alcohols, ethoxylated, and ethoxylated and propoxylated C₆₋₁₆ alcohols, with about 2-10 moles of ethylene oxide, or 1-10 and 1-10 moles of ethylene and propylene oxide per mole of alcohol, respectively, C₁₀₋₁₂ ethoxylated alcohol with 6 moles of ethylene oxide, C₁₀₋₁₂ ethoxylated alcohol with 8 moles of ethylene oxide, alkoxylated phenol ethers, octyl- and nonylphenol ethers, with varying degrees of alkoxylation, such as 1-10 moles of ethylene oxide per mole of phenol, with the alkyl group variable, for example from C₆₋₁₆, with octyl- and nonyl chain lengths, glycosides, alkyl polyglycosides, hydroxylated or alkoxylated members of the foregoing, mixtures of saccharide moieties, alkoxylated or polyalkoxylated saccharides, nonionic alkyl polyglycoside, a mixture of C₉, C₁₀ and C ₁₁ chains in a weight ratio respectively of 20:40:40 (equivalent to an average of C_{10.2}), with x of 1.6, and an HLB of 13.1, amine oxides, mono-long chain, di-short chain, trialkyl amine oxides, ethoxylated or propoxylated amine oxides, lauryl amine oxide, semi-polar nonionic surfactants, alkylamidoalkylenedialkylamine oxide, ethoxylated (1-10 moles of EO/mole) or propoxylated (1-10 moles of PO/mole) surfactant, cocoamidopropyldimethyl amine oxide, phosphine oxides and sulfoxides, tri-methyl-nonyl alcohol ethoxylates, linear ethoxylate sulfates, and combinations of nonionic surfactant including (1) one that is a lower HLB surfactant (HLB between 1-10) capable of solubilizing the hydrophobic UV materials, fragrances and other oils in the formula, and (2) the second is a generally higher HLB surfactant (HLB between 5 and 40) capable of coupling the materials into water.

26. The fabric care composition of claim 23 in which the cationic surfactant is morpholinium ethosulfate.

27. The fabric care composition of claim 23 in which the amphoteric surfactant is selected from one or more of the following: alkylbetaine, alkylamidobetaine, alkylsulfobetaine, alkylamidoalkyldialkylbetaine, and cocoamidopropyldimethyl betaine.

28. The fabric care composition of claim 2 comprising about 0.002% to about 10% by weight of one or more dye-transfer inhibitors, anti-redeposition agents or dye sequestrants.

29. The fabric care composition of claim 2 comprising about 6.215% by weight of one or more dye-transfer inhibitors, anti-redeposition agents or dye sequestrants.

30. The fabric care composition of claim 2 in which the one or more dye-transfer inhibitors, anti-redeposition agents or dye sequestrants is selected from the following: polyvinyl pyrrolidone (PVP), polyvinyl alcohol (PVA), polyvinyl imidazole (PVI), polyamine-N-oxides such as polyvinylpyridine-N-oxide, hydrophobicly or cationicly modified PVP, copolymers of any of the foregoing, Lupasol®, cationic starches, minerals such as magnesium aluminate and hydrotalcite, proteins and hydrolyzed proteins, polyethylene imines, polyvinyl oxazolidone, enzymatic systems including peroxidases and oxidases, oxidants, cationic and amphoteric surfactants, as well as propylene oxide reaction products, polyamino acids such as polyaspartic acid or polyhistidine, block co-polymers of ethylene oxide and propylene oxide, polyamines and polyamides, cationic starches, methyl cellulose, carboxyalkyl celluloses such as carboxymethyl and carboxyethyl cellulose, guar gum and natural gums, alginic acid, polycarboxylic acids, cyclodextrins and other inclusion compounds.

31. The fabric care composition of claim 2 comprising about 0.002% to about 10% by weight of a dye, pigment and fabric color fixative or finish protectant.

32. The fabric care composition of claim 2 comprising about 6.25% by weight of a dye, pigment and fabric color fixative or finish protectant.

33. The fabric care composition of claim 2 in which the dye, pigment and fabric color fixative or finish protectant is selected from the following: surface-active polymers, quaternized or otherwise cationically charged organic nitrogen compounds, polyethyleneamine, cationic resinous compound, ammonium compounds, fatty acid-diamine condensates including the hydrochloride, acetate, metosulphate and benzyl hydrochloride of oleyldiethyl aminoethylamide, oleylmethyl-diethylenediaminemethsulphate, monostearyl-ethylene diaminotrimethylammonium methosulphate and oxidized products of tertiary amines, derivatives of polymeric alkyldiamines, polyamine-cyanuric chloride condensates and aminated glycerol dichlorohydrins, biguanide polymer, and Lupasol®.

34. The fabric care composition of claim 2 in which the textile lubricant and/or textile softening agent is selected from the following: silicone oils, siloxanes, derivatized silicones and derivatized siloxanes, polysilicones, polysiloxanes, aromatic silicon compounds, silanes and derivatized silanes, polydimethylsiloxane, a polydiorganosiloxane gum or an admixture of a polydiorganosiloxane gum as previously indicated together with a volatile cyclic silicone, polydimethylsiloxanes, trimethylsiloxy, hydroxy, or methoxy terminated polydimethylsiloxanes, polydimethylsiloxane gums, polydiorganosiloxane gums essentially composed of monomethylsiloxane, trimethylsiloxane, methylvinylsiloxane, methylethylsiloxane, diethylsiloxane, methylphenylsiloxane, diphenylsiloxane, ethylphenylsiloxane, vinylethylsiloxane, phenylvinylsiloxane, 3,3,3-trifluoropropylmethylsiloxane, dimethylphenylsiloxane, methylphenylvinylsiloxane, dimethylethylsiloxane, 3,3,3-trifluoropropyldinethylsiloxane, mono-3,3,3-trifluoropropylsiloxane, monophenylsiloxane, monovinylsiloxane, insoluble polydiorganosiloxanes, volatile cyclic silicones including polydimethylcyclosiloxanes, octamethylcyclotetrasiloxane and decamethylcyclopentasiloxane, cationic fabric softener compounds, quaternary ammonium or imidazolinium compounds, distearyl dimethylammonium chloride, ditallow dimethylammonium chloride, dioleyl dimethylammonium chloride, ditallow methylhydroxy ethylammonium chloride, ditallow methylhydroxypropyl ammonium chloride and dimyristyl diethyl ammonium bromide, imidazolinium-type, 1 methyl-1-alkylamidoethyl 1-2-alkylimidazolinium methylsulfate, and methyl bis (oleylamidoethyl) 2-hydroxyethyl ammonium methyl sulfate.

35. The fabric care composition of claim 2 comprising about 0.002% to about 10% by weight of hardness and metal ion sequestrants and crystal growth inhibitors.

36. The fabric care composition of claim 2 comprising about 0.625% by weight of hardness and metal ion sequestrants and crystal growth inhibitors.

37. The fabric care composition of claim 2 in which the hardness and metal ion sequestrants and crystal growth inhibitors is selected from the following: phosphate salts, phosphonate salts, acrylic-maleic copolymers, organo diphosphonic acid or one of its salts/complexes, ethylene diphosphonic acid, ethane 1-hydroxy-1, 1-diphosphonic acid (HEDP), ethylenediaminetetraacetates (EDTA), N-hydroxyethylethylenediaminetriacetates, nitrilotriacetates (NTA), ethylene diamine tetraproprionates, ethylene diamine-N,N′-diglutamates, 2-hydroxypropylenediamine-N,N′-disuccinates, triethylenetetraaminehexacetates, diethylenetriaminepentaacetates (DETPA), and ethanoldiglycines, alkali metal, ammonium, and substituted ammonium salts thereof, amino phosphonates, ethylenediaminetetrakis (methylene phosphonates), diethylenetriamine-N,N,N′,N″,N″-pentakis(methane phosphonate) (DETMP) and 1-hydroxyethane-1,1-diphosphonate (HEDP), ethylene diamine-N,N′-disuccinate, simple polycarboxylates such as citrate, oxydisuccinate and NTA.

38. The fabric care composition of claim 2 comprising about 0.002% to about 1% by weight of one or more chlorine and/or active oxygen scavengers or neutralizers.

39. The fabric care composition of claim 2 comprising about 0.3% by weight of one or more chlorine and/or active oxygen scavengers or neutralizers.

40. The fabric care composition of claim 2 in which the one or more chlorine and/or active oxygen scavengers or neutralizers is selected from the following: sodium thiosulfate, butylated hydroxytoluene and butylated hydroxyanisole, hydroxyamine compounds, primary and secondary amines, including primary and secondary fatty amines, ammonium salts including chloride, sulfate, amine-functional polymers, amino acid homopolymers with amino groups and their salts, polyarginine, polylysine, polyhistidine, amino acid copolymers with amino groups and their salts, amino acids and their salts, arginine, histidine, lysine reducing anions such as sulfite, bisulfite, thiosulfate, nitrite, antioxidants, ascorbate, carbamate, phenols, ammonium chloride, monoethanolamine, diethanolamine, tris(hydroxymethyl)aminomethane, hexamethylenetetramine, water-soluble polyethyleneimines, polyamines, polyvinylamines, polyamineamides and polyacrylamides, polyethyleneimines and polyamineamides.

41. A method for fabric care utilizing a fabric care liquid, liquid-gel or gelled composition comprising about 0.001% to about 5% by weight of one or more fabric care enzymes, the fabric care enzymes effective for aiding in preventing pilling fuzzing, staining and other deterioration of fabric fibers, about 0.001% to about 20% by weight of one or more UV protectants, the one or more UV protectants for brightening and preventing light caused photo fading or other damage to fabrics, about 0.001% to about 60% by weight of one or more surface active dispersing, emulsifying and/or solubilizing agent, the one or more surface active dispersing, emulsifying and/or solubilizing agent principally comprised of surfactants, co-surfactants, hydrotropes and solvents selected to solubilize or stabilize the composition, about 0.001% to about 20% by weight of one or more dye-transfer inhibitors, anti-redeposition agents or dye sequestrants, the one or more dye-transfer inhibitors, anti-redeposition agents or dye sequestrants to prevent re-deposition of dyes which have become transient from other fabrics, about 0.001% to about 20% by weight of a dye, pigment and fabric color fixative or finish protectant, the dye, pigment and fabric color fixative or finish protectant to lock-in dyes and pigments to prevent their loss in quantity or quality, about 0% to about 5% by weight of a textile lubricant and/or textile softening agent, the lubricant and/or textile softening agent to coat the textiles and reduce inter-fiber and fiber surface friction; about 0.001% to about 20% by weight of hardness and metal ion sequestrants and crystal growth inhibitors, the hardness and metal ion sequestrants and crystal growth inhibitors to bind free ions to prevent formation of insoluble precipitate compounds; about 0.001% to about 6% by weight of one or more chlorine and/or active oxygen scavengers or neutralizers which act to neutralize oxidizing agents, i.e., those species with oxidation potential; and about 0% to about 8% by weight one or more chemicals from the following: handling, storage, processing agents to modify elastic and viscous phase properties, anti-foaming or frothing agents, anti-microbial, anti-bacterial or anti-fungal agents, pH buffer, adjustment and/or modification, as needed, aesthetic dyes and/or fragrances, the method comprising the following step(s):
combining a predetermined volume of the fabric care composition, a larger predetermined volume of water and the fabric such that a dilute aqueous solution of the composition is allowed to soak into the fibers of the fabric, with chlorine and/or oxygen scavenger present, thereby rendering the fabric: (1) free of pilling, fuzzing and/or staining; (2) UV light protected; (3) free of undesired dye transfer from the fabric or to the fabric; (4) color fixed or finish protected, with reduced crystal growth or hardness present; and (5) optionally softened or lubricated.

42. The method of claim 41 further comprising the following step(s):
washing the fabric with a suitable cleaning composition.

43. The method of claim 42 in which the washing step(s) is performed subsequent to the combining step(s).

44. The method of claim 42 in which the washing step(s) is performed prior to the combining step(s).

45. The method of claim 42 in which the washing step(s) and the combining step(s) are performed essentially simultaneously.

46. The method of claim 41 in which the combining step(s) is performed utilizing a device adapted for selective retention and dispensation of a predetermined amount, quantity or dosage of the fabric care composition at a predetermined rate.

47. A method of cleaning a combination of clothes wherein the combination of clothes have a combination of susceptibilities to different types of color damage, the different types of color damage including, but not limited to, color damage caused by UV light, pilling or fuzzing of the clothing, redeposition of color from solution, fading of the color in the washing process, chlorine and color abrasion, the method comprising the steps of:
(a) determining the different types of damage which the combination of clothes are susceptible to; and
(b) utilizing a composition which provides protection to clothes for each the different types of damage determined in step (a).

48. A method of cleaning clothes susceptible to color damage caused by UV light, pilling/fuzzing of the clothing, redeposition of other color from solution, fading of the color in the washing process, chlorine or color abrasion, the method comprising the steps of:
(a) determining whether the clothes to be cleaned are susceptible to color damage caused by UV light, pilling/fuzzing of the clothing, redeposition of other color from solution, fading of the color in the washing process, chlorine or color abrasion; and
(b) utilizing a cleaning composition which provides protection to the clothes for color damage caused by UV light, pilling/fuzzing of the clothing, redeposition of other color from solution, fading of the color in the washing process, chlorine or color abrasion, as required.

49. A method of treating a combination of clothes during cleaning wherein the combination of clothes have a combination of susceptibilities to different types of color damage, the different types of color damage including, but not limited to, color damage caused by UV light, pilling or fuzzing of the clothing, redeposition of color from solution, fading of the color in the washing process, chlorine and color abrasion, the method comprising the steps of:
(a) determining the different types of damage which the combination of clothes are susceptible to; and
(b) utilizing a composition which provides protection to clothes for each the different types of damage determined in step (a).

50. A method of treating clothes susceptible to color damage caused by UV light, pilling/fuzzing of the clothing, redeposition of other color from solution, fading of the color in the washing process, chlorine or color abrasion, the method comprising the steps of:
(a) determining whether the clothes to be treated are susceptible to color damage caused by UV light, pilling/fuzzing of the clothing, redeposition of other color from solution, fading of the color in the washing process, chlorine or color abrasion; and
(b) utilizing a treatment composition which provides protection to the clothes for color damage caused by UV light, pilling/fuzzing of the clothing, redeposition of other color from solution, fading of the color in the washing process, chlorine or color abrasion, as required.

51. A color care composition for treating clothes susceptible to color damage caused by UV light, pilling/fuzzing of the clothing, redeposition of other color from solution, fading of the color in the washing process, chlorine or color abrasion, the composition comprising:
(a) a UV protecting effective amount of one or more UV protectants;
(b) an enzymatically effective amount of one or more fabric care enzymes;
(c) a dye-transfer inhibiting and anti-redeposition effective amount of one or more dye-transfer inhibitors, anti-redeposition agents or dye sequestrants;
(d) a color fixing or finish protecting effective amount of a dye, pigment and fabric color fixative or finish protectant;
(e) a chlorine and/or oxygen scavenging effective amount of one or more chlorine and/or active oxygen scavengers or neutralizers;
(f) a lubricating or softening effective amount of a textile lubricant and/or softening agent; and
(g) a sequestering and crystal growth inhibiting effective amount of hardness and metal ion sequestrants and crystal growth inhibitors and anti-encrustation agents.

52. A method of color treating a plurality of articles of a plurality of different types of fabric to protect them from a plurality of types of color damage, the method comprising the steps of identifying the plurality of fabrics, identifying the plurality of types of color damage which the plurality of articles are susceptible to, and determining therefrom the most effective color care composition for treating the plurality of articles simultaneously.

53. The method of claim 52 in which the step of determining the most effective color care composition comprises utilizing statistical analysis of the identifications of the plurality of articles, the plurality of fabrics and the plurality of types of color damage which the plurality of articles are susceptible to.

54. The method of claim 53 further comprising the step of optimizing the color care composition with regards to providing as much color protection as possible to as many different types of fabric as possible.

55. The method of claim 53 further comprising the step of optimizing the color care composition with regards to providing as much color protection as possible to the fabrics identified the most frequently.

56. The method of claim 53 further comprising the step of optimizing the color care composition with regards to providing as much color protection as possible from as many different sources of color damage identified as possible.

57. The method of claim 53 further comprising the step of optimizing the color care composition with regards to providing as much color protection as possible from the sources of color damage identified most frequently.

58. A method of formulating a color care composition wherein the composition is for use treating a plurality of articles made of a plurality of types of fabric to protect them from color damage associated with a plurality of causes, the method comprising the steps of identifying the plurality of types of fabrics, identifying the plurality of different types of color damage which the plurality of articles are susceptible to, and determining therefrom the most effective color care composition for treating the plurality of articles simultaneously.

59. A method of formulating a color care composition wherein the composition is used to treat a large number of different types of articles of clothing made of a large number of different types of fabric and to protect them from color damage associated with a large number of different causes, the method comprising the steps of identifying the large number of different types of articles of clothing, identifying the types of fabrics used in the large number of articles of clothing, identifying the large number of different types of color damage which the large number of different types of fabric are susceptible to, and determining therefrom the most effective color care composition for treating the large number of articles simultaneously.
